(19) United States
(12) Patent Application Publication
(10) Pub. No.: US 2026/0239408 A1
(43) Pub. Date: Aug. 13, 2026

(54) METHODS, DEVICES, AND COMPUTER READABLE STORAGE MEDIUM FOR BEAM ACTIVATION AND SWITCHING

(71) Applicant: Huawei Technologies Co., Ltd., Shenzhen (CN)

(72) Inventors: Aman Jassal, Stittsville (CA); Amine Maaref, Ottawa (CA); Jianglei Ma, Ottawa (CA)

(21) Appl. No.: 19/635,192

(22) Filed: Mar. 31, 2026

Related U.S. Application Data
(63) Continuation of application No. PCT/CN2024/078661, filed on Feb. 27, 2024.
(60) Provisional application No. 63/588,159, filed on Oct. 5, 2023.

(51) Int. Cl. H04W 72/542; H04W 72/044; H04W 84/06

(52) U.S. Cl. CPC H04W 72/542; H04W 72/046; H04W 84/06

(57) ABSTRACT

Example embodiments relate to methods, devices and a computer readable storage medium for beam activation and switching. In an aspect, a terminal device obtains an indication of at least one angular direction. The terminal device communicates signals with a non-terrestrial network device using one of at least one beam associated with the at least one angular direction. In this way, the terminal device can communicate with the non-terrestrial network using a beam associated with one of the indicated angular direction(s).

### CROSS-REFERENCES TO RELATED APPLICATIONS

This application is a continuation of International Application No. PCT/CN2024/078661, filed on Feb. 27, 2024, which claims the benefit and priority to U.S. Patent Application No. 63/588,159 filed Oct. 5, 2023, the entire contents of which are incorporated herein by reference in its entirety.

### FIELD

Example embodiments of the present disclosure generally relate to the field of communication, and in particular, to methods, devices and a computer readable storage medium for beam activation and switching.

### BACKGROUND

Wireless communications system such as fourth generation (4G) system (for example, Long-Term Evolution (LTE) system), fifth generation (5G) system (for example, a new radio (NR) system) have been deployed to provide various types of applications, such as message, voice, video and other data. In NR, non-terrestrial networks (NTNs) are developed, which may utilize spaceborne vehicles or airborne vehicles as a base station or relay for communications between different devices. Solutions in NTNs, which may cooperate with terrestrial networks (TN), to provide communications with acceptable cost (such as power consumption, and/or complexity) are desired.

### SUMMARY

In general, example embodiments of the present disclosure provide a solution for beam activation and switching in terrestrial/non-terrestrial networks.

It is to be understood that the summary section is not intended to identify key or essential features of embodiments of the present disclosure, nor is it intended to be used to limit the scope of the present disclosure. Other features of the present disclosure will become easily comprehensible through the following description.

In a first aspect, there is provided a method performed by a terminal device. The method comprises: obtaining, by a terminal device, an indication of at least one angular direction. The method further comprises: communicating signals with a non-terrestrial network device using one of at least one beam associated with the at least one angular direction. In this way, the terminal device can communicate with the non-terrestrial network using a beam associated with one of the indicated angular direction(s). Instead of accessing a cell of a NTN device, which moves along its orbit, for a limited amount of time, the terminal device may communicate with NTN devices in that angular direction, thus improving the link quality with the NTN devices in the non-terrestrial networks.

In some implementations of the present disclosure, the method further comprises receiving an association between one or more indications of one or more angular directions and one or more beams. The one or more angular directions comprise the at least one angular direction and the one or more beams comprise the at least one beam. In this way, the terminal device may be aware of an angular direction towards which to steer its reception and/or transmission beam when obtaining an indication of the angular direction. The resource overhead for the indication of the angular direction for communication with the NTN device may be reduced.

In some implementations of the present disclosure, the method further comprises activating the at least one beam associated with the at least one angular direction; and deactivating remaining beams associated with remaining angular directions different from the at least one angular direction. The one or more angular directions comprise the remaining angular directions and the one or more beams comprise the remaining beams. In this way, multiple beams of the terminal device may be activated, which allows the terminal device to receive, detect and measure reference signals from multiple NTN devices located at different directions, thus improving communication quality of the terminal device with the non-terrestrial network.

In some implementations of the present disclosure, the indication of the at least one angular direction is carried in one of the following: a media access control (MAC) control element (CE) signaling, a radio resource control (RRC) signaling or downlink control information (DCI). The indication of the association is carried in an RRC signaling. In this way, the angular direction towards which the terminal device is to steer its reception and/or transmission beam may be preconfigured and dynamically or semi-statically activated based on the actual scenario. The terminal device and the NTN device may have a common understanding on the angular direction towards which the terminal device is to steer its reception and/or transmission beam. The communication quality of the terminal device with the non-terrestrial network may thus be improved.

In some implementations of the present disclosure, the indication of the at least one angular direction indicates a plurality of angular directions in an order, wherein the order indicates a priority of using the plurality of angular directions. In this way, the terminal device may be able to receive, detect and measure reference signals from NTN devices in different angular directions in a sequential order based on the priority and determine the angular direction towards which to steer its reception and/or transmission beam. The communication quality of the terminal device with the non-terrestrial network may thus be improved.

In some implementations of the present disclosure, one of the at least one angular direction is indicative of a direction applied in at least one of the following: an Azimuth domain; a Zenith domain; or an Elevation domain. In this way, spatial angular directions for the reception and/or transmission beams of the terminal device may be defined.

In some implementations of the present disclosure, the at least one angular direction comprises a plurality of angular directions including a first angular direction and a second angular direction, wherein the at least one beam comprises a first beam associated with the first angular direction and a second beam associated with the second angular direction. Communicating the signals using the one of the at least one beam comprises: receiving the signals using the first beam; and determining a quality degradation associated with the signals received using the first beam, wherein the first beam is associated with an outermost angular direction in a cone region constrained by the plurality of angular directions; and performing a beam switching from the first beam to the second beam. In this way, when the terminal device experiences a quality degradation when communicating using a beam associated with an outmost angular direction, a beam switching of the terminal device may be triggered and the terminal device may steer its reception and/or transmission beams towards another angular direction. The communication quality of the terminal device with the non-terrestrial network may thus be improved.

In some implementations of the present disclosure, the method further comprises transmitting capability information of the terminal device, wherein the cone region is associated with the capability information. In this way, the non-terrestrial networks may be aware of the cone region in which the non-terrestrial network device may communicate with the terminal device.

In some implementations of the present disclosure, determining the quality degradation associated with the signals comprises at least one of the following: determining that a reference signal received power (RSRP) of the signals is below a first threshold for a first duration; determining that a reference signal received quality (RSRQ) of the signals is below a second threshold for a second duration; determining that a signal to interference and noise ratio (SINR) of the signals is below a third threshold for a third duration; or determining that the signals are received using the first beam for a fourth duration. In this way, the terminal device may detect and measure reference signals from NTN devices located at the angular direction and perform a beam switching to another angular direction when the signal quality degrades. The communication quality of the terminal device with the non-terrestrial network may thus be improved.

In some implementations of the present disclosure, the method further comprises receiving a configuration of triggering the beam switching. The configuration comprises at least one of the following: the first threshold and the first duration for the RSRP; the second threshold and the second duration for the RSRQ; the third threshold and the third duration for the SINR; or the fourth duration for the outermost angular direction. In this way, the communication quality of the terminal device with the non-terrestrial network may thus be improved.

In some implementations of the present disclosure, the method further comprises receiving a second indication indicating one of the at least one angular direction. Communicating the signals using the one of the at least one beam comprises: communicating the signals using one beam associated with the one of the at least one angular direction, wherein the one beam belongs to the at least one beam. In this way, a beam may be dynamically activated based on the indication of the associated angular direction.

In some implementations of the present disclosure, the method further comprises receiving an indication of one of the at least one angular direction and an indication of a correction on the one of the at least one angular direction. Communicating the signals using the one of the at least one beam comprises: communicating the signals using one beam associated with the one of the at least one angular direction applied with the correction, wherein the one beam belongs to the at least one beam. In this way, the terminal device may steer its reception and/or transmission beam towards an angular direction with a direction correction, thus improving the communication quality of the terminal device with the non-terrestrial network.

In some implementations of the present disclosure, communicating the signals using the one of the at least one beam comprises: detecting reference signals using the at least one beam; determining a beam with a strongest reference signal strength based on the detected reference signals, wherein the beam belongs to the at least one beam; and communicating the signals using the beam with the strongest reference signal strength. In this way, the communication quality of the terminal device with the non-terrestrial network may thus be improved.

In some implementations of the present disclosure, the at least one angular direction comprises a plurality of angular directions, the method further comprises: receiving an indication of a default angular direction, wherein the default angular direction belongs to the plurality of angular directions; and performing a beam switching to a beam associated with the default angular direction upon determining one of the following: a quality degradation associated with the signals received using a first beam among the plurality of angular directions, wherein the first beam is associated with an outermost angular direction in a cone region constrained by the plurality of angular directions; a state transition of the terminal device from an RRC connected state to a power sleep mode; or a state transition of the terminal device from an RRC connected state to an idle mode. In this way, the terminal device may steer its reception and/or transmission beam towards a default direction in some specific scenarios, thus guaranteeing the communication quality of the terminal device with the non-terrestrial network and reducing the power consumption for finding a suitable beam angular direction.

In some implementations of the present disclosure, the default angular direction is associated with a time and/or frequency domain pattern indicative of resources for communicating the signals. In this way, the default angular direction may be adapted to the resource allocation and the communication quality of the terminal device with the non-terrestrial network may be improved.

In a second aspect, there is provided a method performed by a non-terrestrial network device. The method comprises: transmitting, by a non-terrestrial network device, an indication of at least one angular direction, wherein the at least one angular direction is associated with at least one beam; and communicating signals with a terminal device, wherein the signals are communicated by the terminal device using one of the at least one beam. In this way, the non-terrestrial network device may communicate with the terminal device based on the angular direction towards which the terminal device steers its reception and/or transmission beam, thus improving the link quality with the terminal device.

In some implementations of the present disclosure, the method further comprises transmitting an association between one or more indications of one or more angular directions and one or more beams. The one or more angular directions comprise the at least one angular direction and the one or more beams comprise the at least one beam. In this way, the non-terrestrial network device may be aware of an angular direction towards which the terminal device is to steer its reception and/or transmission beam. The resource overhead for the indication of the angular direction for communication with the NTN device may be reduced.

In some implementations of the present disclosure, the indication of the at least one angular direction is carried in one of the following: a media access control (MAC) control element (CE) signaling, a radio resource control (RRC) signaling or downlink control information (DCI). The indication of the association is carried in an RRC signaling. In this way, the angular direction towards which the terminal device is to steer its reception and/or transmission beam may be preconfigured and dynamically or semi-statically activated based on the actual scenario. The terminal device and the NTN device may have a common understanding on the angular direction towards which the terminal device is to steer its reception and/or transmission beam. The communication quality of the terminal device with the non-terrestrial network may thus be improved.

In some implementations of the present disclosure, the indication of the at least one angular direction indicates a plurality of angular directions in an order, wherein the order indicates a priority of using the plurality of angular directions. In this way, the communication quality of the terminal device with the non-terrestrial network may thus be improved.

In some implementations of the present disclosure, one of the at least one angular direction is indicative of a direction applied in at least one of the following: an Azimuth domain; a Zenith domain; or an Elevation domain. In this way, spatial angular directions for the reception and/or transmission beams of the terminal device may be defined.

In some implementations of the present disclosure, the at least one angular direction comprises a plurality of angular directions, and the method further comprises: transmitting a configuration of triggering a beam switching. The configuration comprises at least one of the following: a first threshold and a first duration for a reference signal received power (RSRP); a second threshold and a second duration for a reference signal received quality (RSRQ); a third threshold and a third duration for a signal to interference and noise ratio (SINR); or a fourth duration for an outermost angular direction in a cone region constrained by the plurality of angular directions. In this way, the communication quality of the terminal device with the non-terrestrial network may thus be improved.

In some implementations of the present disclosure, the method further comprises receiving capability information of the terminal device, wherein the cone region is associated with the capability information. In this way, the non-terrestrial networks may be aware of the cone region in which the non-terrestrial network device may communicate with the terminal device.

In some implementations of the present disclosure, the method further comprises transmitting a second indication indicating one of the at least one angular direction. The signals are communicated by the terminal device using one beam associated with the one of the at least one angular direction, wherein the one beam belongs to the at least one beam. In this way, a beam may be dynamically activated based on the indication of the associated angular direction.

In some implementations of the present disclosure, the method further comprises transmitting an indication of one of the at least one angular direction and an indication of a correction on the one of the at least one angular direction. The signals are communicated by the terminal device using one beam associated with the one of the at least one angular direction applied with the correction, wherein the one beam belongs to the at least one beam. In this way, the non-terrestrial device may indicate the terminal device to its reception and/or transmission beam towards an angular direction with a direction correction, thus improving the communication quality of the terminal device with the non-terrestrial network.

In some implementations of the present disclosure, the method further comprises transmitting an indication of a default angular direction, wherein the default angular direction belongs to the at least one angular direction. In this way, the terminal device may be able to steer its reception and/or transmission beam towards a default direction in some specific scenarios, thus guaranteeing the communication quality of the terminal device with the non-terrestrial network and reducing the power consumption for finding a suitable beam angular direction.

In some implementations of the present disclosure, the default angular direction is associated with a time and/or frequency domain pattern indicative of resources for communicating the signals. In this way, the default angular direction may be adapted to the resource allocation and the communication quality of the terminal device with the non-terrestrial network may be improved.

In a third aspect, there is provided a terminal device. The terminal device comprises: a transceiver; and a processor communicatively coupled with the transceiver. The processor is configured to: obtain an indication of at least one angular direction associated with at least one beam; and communicate signals with a non-terrestrial network device using one of the at least one beam associated with the at least one angular direction. In this way, the terminal device can communicate with the non-terrestrial network using a beam associated with one of the indicated angular direction(s). Instead of accessing a cell of a NTN device, which moves along its orbit, for a limited amount of time, the terminal device may communicate with NTN devices in that angular direction, thus improving the link quality with the NTN devices in the non-terrestrial networks.

In a fourth aspect, there is provided a network device. The network device comprises: a transceiver; and a processor communicatively coupled with the transceiver. The processor is configured to: transmit, via the transceiver, an indication of at least one angular direction, wherein the at least one angular direction is associated with at least one beam; and communicate signals with a terminal device, wherein the signals are communicated by the terminal device using one of the at least one beam. In this way, the non-terrestrial network device may communicate with the terminal device based on the angular direction towards which the terminal device steers its reception and/or transmission beam, thus improving the link quality with the terminal device.

In a fifth aspect, there is provided a non-transitory computer readable medium. The non-transitory computer readable medium comprises computer program stored thereon, the computer program, when executed on at least one processor, causing the at least one processor to perform the method of the first aspect, the second aspect, or any possible implementation of the first aspect or the second aspect.

In a sixth aspect, there is provided a chip. The chip comprising at least one processing circuit configured to perform the method of the first aspect, the second aspect, or any possible implementation of the first aspect or the second aspect.

In a seventh aspect, there is provided a system. The system comprising at least one terminal device of the third aspect and the at least one network device of the fourth aspect.

### BRIEF DESCRIPTION OF THE DRAWINGS

Some example embodiments will now be described with reference to the accompanying drawings, in which:

FIG. 1 illustrates an example of a communication system in which some example embodiments of the present disclosure may be implemented;

FIG. 2 illustrates a detailed example of the communication system of FIG. 1 in which some example embodiments of the present disclosure may be implemented;

FIG. 3 illustrates an example of an electronics device and a base station in which some example embodiments of the present disclosure may be implemented;

FIG. 4 illustrates example modules in a device or apparatus in which some example embodiments of the present disclosure may be implemented;

FIG. 5 illustrates an example of a communication system with T-TRP and NT-TRP in which some example embodiments of the present disclosure may be implemented;

FIG. 6 illustrates another example of a communication system with T-TRP and NT-TRP in which some example embodiments of the present disclosure may be implemented;

FIG. 7 illustrates another example of a communication system with T-TRP and NT-TRP in which some example embodiments of the present disclosure may be implemented;

FIG. 8 illustrates another example of a communication system with T-TRP and NT-TRP in which some example embodiments of the present disclosure may be implemented;

FIG. 9 illustrates an example signaling chart of a communication process in which some example embodiments of the present disclosure may be implemented;

FIG. 10 illustrates an example of a coverage area on the ground in which some example embodiments of the present disclosure may be implemented;

FIG. 11 illustrates an example of a scenario where three beam angular directions are activated for a UE to communicate with NT-TRPs in which some example embodiments of the present disclosure may be implemented;

FIG. 12A illustrates an example of a NT-TRP transmitting multiple beams in which some example embodiments of the present disclosure may be implemented;

FIG. 12B illustrates an example of a triggering of a BAI switching based on a visibility cone in which some example embodiments of the present disclosure may be implemented;

FIG. 12C illustrates an example of a BAI switching based on a visibility cone in which some example embodiments of the present disclosure may be implemented;

FIG. 13 illustrates an example of a default BAI in which some example embodiments of the present disclosure may be implemented;

FIG. 14 illustrates an example of a method implemented at a terminal device in which some example embodiments of the present disclosure may be implemented;

FIG. 15 illustrates an example of a method implemented at a NTN device in which some example embodiments of the present disclosure may be implemented;

FIG. 16 illustrates a block diagram of a device that may be used for implementing devices and methods in accordance with some embodiments of the present disclosure;

FIG. 17 illustrates a schematic diagram of a structure of an apparatus in accordance with some embodiments of the present disclosure; and

FIG. 18 illustrates a schematic diagram of a structure of another apparatus in accordance with some embodiments of the present disclosure.

Throughout the drawings, the same or similar reference numerals represent the same or similar elements.

### DETAILED DESCRIPTION

Principles of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment”, “an embodiment”, “an example embodiment”, and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms. The words “first”, “second”, etc., when used before a same term (e.g., ED, or an operating step) does not mean an order or a sequence of the term. For example, the “first ED” and the “second ED”, means two different EDs without specially indicated, and similarly, the “first step” and the “second step” means two different operating steps without specially indicated, but does not mean the first step have to happen before the second step. The real order depends on the logic of the two steps.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise. Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

It should be noted that the message in the disclosure could be replaced with information, which may be carried in one single message, or be carried in more than one separate message. Without special noting, the terms “apparatus” and “device” are used exchangeable, and the terms “identity” and “identifier” are used exchangeable.

The terms “coupled”, “coupling” or “connected” as used herein may have several different meanings depending on the context in which these terms are used. For example, as used herein, the terms coupled, coupling, or connected may indicate that two elements or devices are directly connected to one another or connected to one another through one or more intermediate elements or devices via a mechanical element depending on the particular context.

The term “receive”, “detect” and “decode” as used herein may have several different meanings depending on the context in which these terms are used. For example, without special note, the term “receive” may indicate that information (e.g., DCI, or MAC-CE, RRC signaling or TB) is received successfully by the receiving node, which means the receiving side correctly detect and decode it. In this scenario, “receive” may cover “detect” and “decode” or may indicates same thing, e.g., “receive paging” means decoding paging correctly and obtaining the paging successfully, accordingly, “the receiving side does not receive paging” means the receiving side does not detect and/or decoding the paging. “paging is not received” means the receiving side tries to detect and/or decoding the paging, but not obtain the paging successfully. The term “receive” may sometimes indicate that a signal arrives at the receiving side, but does not mean the information in the signal is detected and decoded correctly, then the receiving side need perform detecting and decoding on the signal to obtain the information carried in the signal. In this scenario, “receive”, “detect” and “decode” may indicate different procedure at receiving side to obtain the information.

When the functions are implemented in the form of a software functional unit and sold or used as an independent product, the functions may be stored in a computer-readable storage medium. Based on such an understanding, the technical solutions of this application essentially, or the part contributing to the prior art, or some of the technical solutions may be implemented in a form of a software product. The software product is stored in a storage medium, and includes several instructions for instructing a computer device (which may be a personal computer, a server, or a network device) to perform all or some of the steps of the methods described in the embodiments of this application. The foregoing storage medium includes: any medium that can store program code, such as a USB flash drive, a removable hard disk, a read-only memory (Read-Only Memory, ROM), a random access memory (Random Access Memory, RAM), a magnetic disk, or an optical disc.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

User Equipment (UE) position information is often used in cellular communication networks to improve various performance metrics for the network. Such performance metrics may, for example, include capacity, agility, and efficiency. The improvement may be achieved when elements of the network exploit the position, the behavior, the mobility pattern, etc., of the UE in the context of a priori information describing a wireless environment in which the UE is operating.

A sensing system may be used to help gather UE pose information, including its location in a global coordinate system, its velocity and direction of movement in the global coordinate system, orientation information, and the information about the wireless environment. “Location” is also known as “position” and these two terms may be used exchangeable herein. Examples of well-known sensing systems include RADAR (Radio Detection and Ranging) and LIDAR (Light Detection and Ranging). While the sensing system can be separate from the communication system, it could be advantageous to gather the information using an integrated system, which reduces the hardware (and cost) in the system as well as the time, frequency, or spatial resources needed to achieve both functionalities. However, using the communication system hardware to perform sensing of UE pose and environment information is a highly challenging and open problem. The difficulty of the problem relates to factors such as the limited resolution of the communication system, the dynamicity of the environment, and the huge number of objects whose electromagnetic properties and position are to be estimated.

Accordingly, integrated sensing and communication (also known as integrated communication and sensing, joint sensing and communication, and other similar names) is a desirable feature in existing and future communication systems.

Referring to FIG. 1, as an illustrative example without limitation, a simplified schematic illustration of a communication system is provided. The communication system 100 (which may be a wireless system) comprises a radio access network 120. The radio access network (RAN) 120 may be a next generation (e.g. sixth generation (6G) or later) radio access network, or a legacy (e.g. 5G, 4G, 3G or 2G) radio access network. One or more communication electronic device (ED) 110a, 110b, 110c, 110d, 110e, 110f, 110g, 110h, 110i, 110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. The communication system 100 may also comprise a public switched telephone network (PSTN) 140, the internet 150, and other networks 160.

In general, the communication system 100 enables multiple wireless or wired elements to communicate data and other content. The communication system 100 may provide content, such as voice, data, video, and/or text, via broadcast, multicast, groupcast, unicast, etc. And the communication system 100 may provide a wide range of communication services and applications (such as earth monitoring, remote sensing, passive sensing and positioning, navigation and tracking, autonomous delivery and mobility, etc.)

The communication system 100 may operate by sharing resources, such as carrier spectrum bandwidth, between its constituent elements.

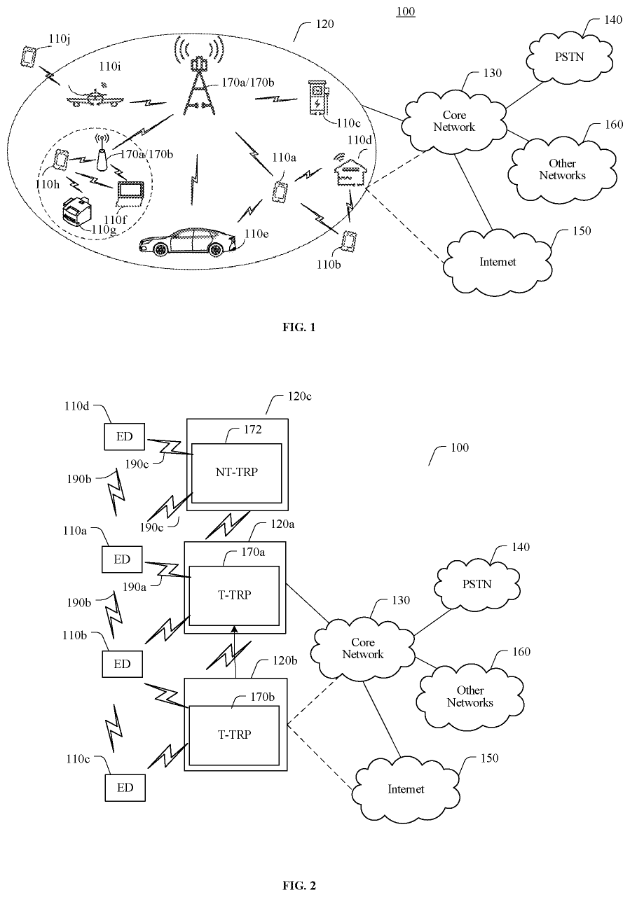

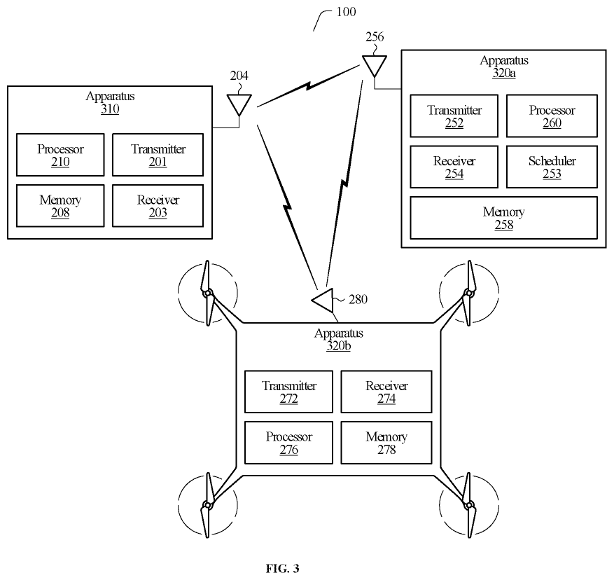

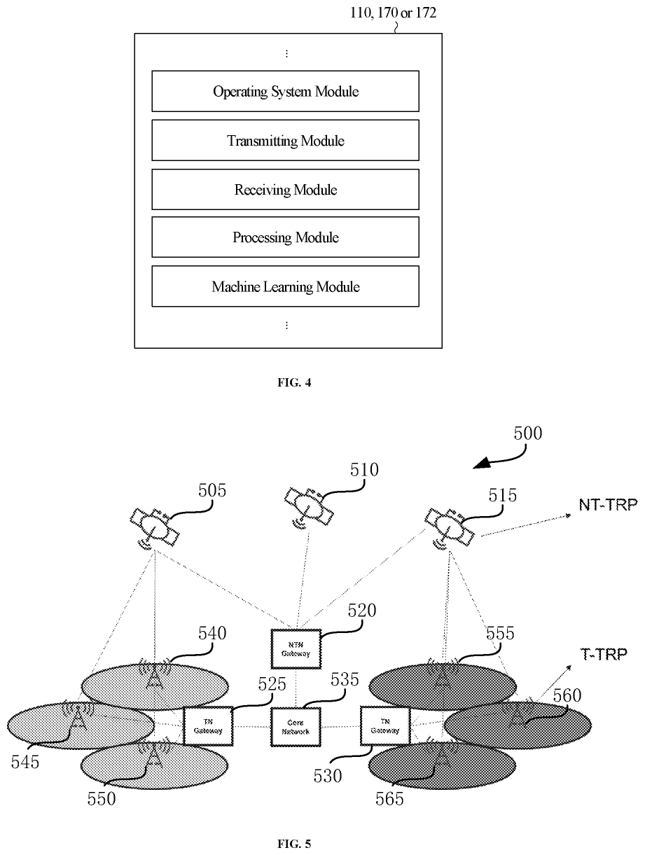

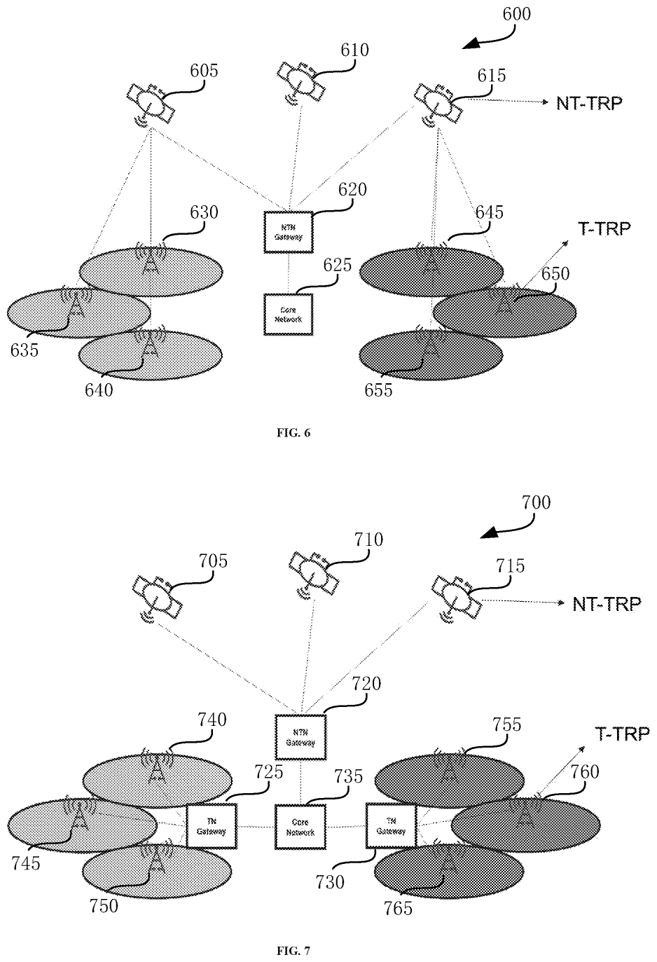

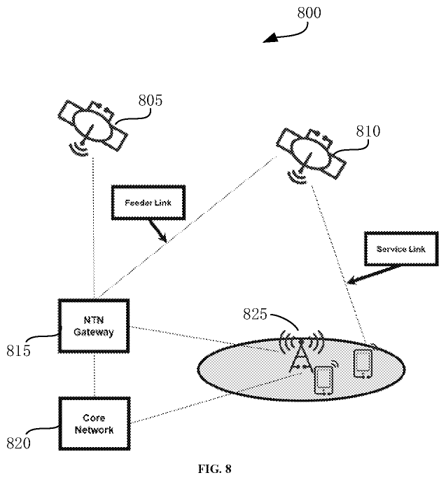

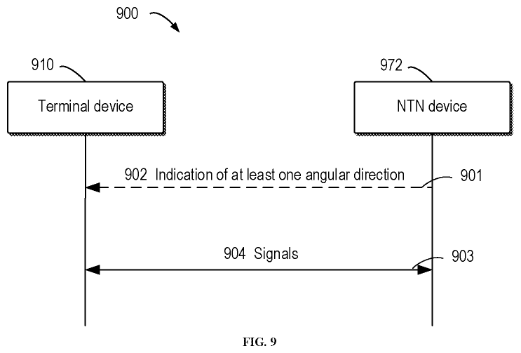

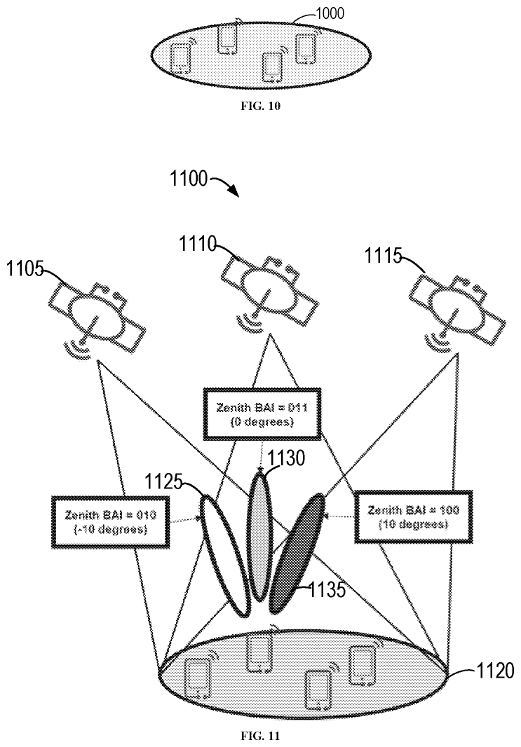

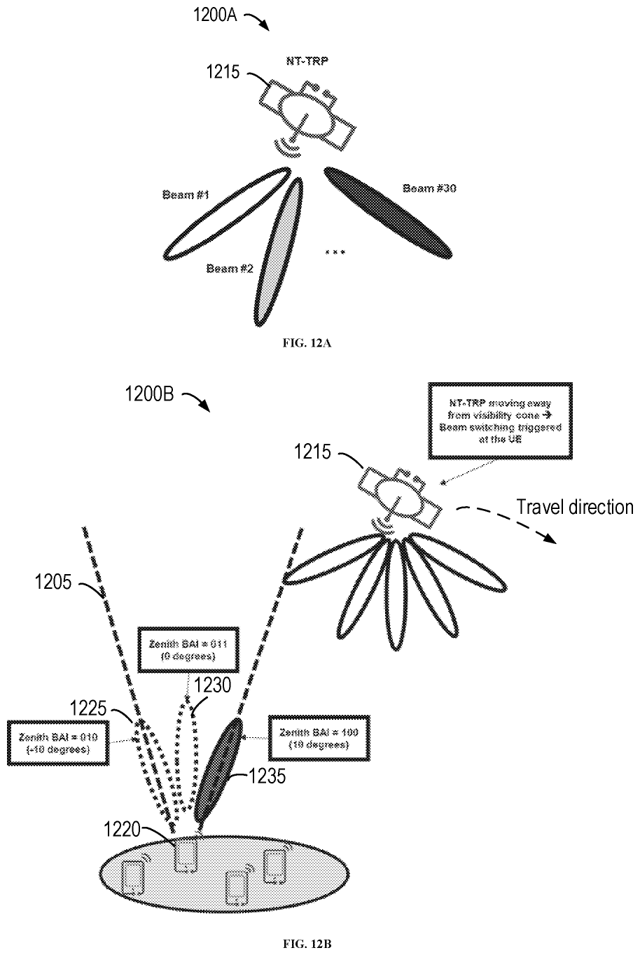

FIG. 2 illustrates more detailed example for communication system 100. The communication system 100 may include a terrestrial communication system and/or a non-terrestrial communication system. The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. The heterogeneous network may achieve better overall performance through efficient multi-link joint operation, more flexible functionality sharing, and faster physical layer link switching between terrestrial networks and non-terrestrial networks. The terrestrial communication system and the non-terrestrial communication system could be considered sub-systems of the communication system.

Same as in the example shown in FIG. 1, in the example shown in FIG. 2, the communication system 100 may include ED 110a, 110b, 110c, 110d (generically referred to as ED 110), and RAN 120a, 120b. In addition, the communication system 100 may also include a non-terrestrial communication network 120c. The communication system 100 may also include one or more of a core network 130, a public switched telephone network (PSTN) 140, the Internet 150, and other networks 160. The RANs 120a, 120b include respective RAN nodes such as base stations (BSs) 170a, 170b, which may be generically referred to as terrestrial transmit and receive points (T-TRPs) 170a, 170b. In one implementations, the non-terrestrial communication network 120c includes a RAN node such as an access node (or base station) 172, which may be generically referred to as a non-terrestrial transmit and receive point (NT-TRP) 172. As may be surmised on the basis of similarity in reference numerals, the non-terrestrial communication network 120c may be considered to be a radio access network, with operational aspects in common with the RANs 120a, 120b. In another implementation, the non-terrestrial communication network 120c may include at least one non-terrestrial network (NTN) device and at least one corresponding terrestrial network device, wherein the at least one non-terrestrial network device works as a transport layer device and the at least one corresponding terrestrial network device works as a RAN node, which communicates with the ED via the non-terrestrial network device. In addition, there may be a NTN gateway in the ground (i.e., referred as a terrestrial network device) also as a transport layer device to communication with both the NTN device, and the RAN node communicates with the ED via the NTN device and the NTN gateway. In some implementations, the NTN gateway and the RAN node may be located in the same device.

Any ED 110 may be alternatively or additionally configured to interface, access, or communicate with any T-TRP 170a,170b and NT-TRP 172, the Internet 150, the core network 130, the PSTN 140, the other networks 160, or any combination of the preceding. In some examples, ED 110a may communicate an uplink and/or downlink transmission over a terrestrial air interface 190a with T-TRP 170a. In some examples, the EDs 110a, 110b, 110c, and 110d may also communicate directly with one another via one or more sidelink (SL) air interfaces 190b. In some examples, ED 110d may communicate an uplink and/or downlink transmission over a non-terrestrial air interface 190c with NT-TRP 172.

The air interfaces 190a and 190b may use similar communication technology, such as any suitable radio access technology. For example, the communication system 100 may implement one or more channel access methods, such as code division multiple access (CDMA), space division multiple access (SDMA), time division multiple access (TDMA), frequency division multiple access (FDMA), orthogonal FDMA (OFDMA), or single-carrier FDMA (SC-FDMA, also known as discrete Fourier transform spread OFDMA, DFT-s-OFDMA) in the air interfaces 190a and 190b. The air interfaces 190a and 190b may utilize other higher dimension signal spaces, which may involve a combination of orthogonal and/or non-orthogonal dimensions.

The non-terrestrial air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs 110 and one or multiple NT-TRPs 172 for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the Internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the Internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies, and incorporate multiple transceivers necessary to support such.

In addition, the communication system 100 may comprising a sensing agent (not shown in the figure) to manage the sensed data from ED no and or the T-TRP 170 and/or NT-TRP 172. In one implementation, the sensing agent is located in the T-TRP 170 and/or NT-TRP 172. In another implementation, the sensing agent is a separate node which has interface to communicate with the core network 130 and/or the RAN 120 (e.g., the T-TRP 170 and/or NT-TRP 172).

FIG. 3 illustrates example of an Apparatus 310 wirelessly communicating with at least one of two apparatuses (e.g., Apparatus 320a and Apparatus 320b, referred as Apparatus 320) in a communication system, e.g., the communication system 100C, according to one embodiment. The Apparatus 310 may be a UE (e.g., ED no in FIG. 1 or 2). The Apparatus 320a may be a terrestrial network device (e.g., T-TRP 170 as shown in FIG. 1 or 2), and Apparatus 320b may be a non-terrestrial network device (e.g., NT-TRP 172 as shown in FIG. 2). However, this is not necessary. For example, Apparatus 320a may be a NT-TRP, and 320b may be a T-TRP, both Apparatus 320a and 320b may be T-TRPs or NT-TRPs, according to present disclosure. In the following, the ED 110 as an example of the Apparatus 310 is described, and T-TRP 170 as an example of Apparatus 320a is described, and NT-TRP 172 as an example of Apparatus 320a is described. Although only one Apparatus 310, one Apparatus 320a and one Apparatus 320b Please note that the number of Apparatus 310 (e.g. ED 110) could be one or more, and the number of Apparatus 320a and/or 320b could be one or more. For example, one ED 110 may be served by only one T-TRP 170 (or one NT-TRP172), by more than one T-TRP 170, by more than one NT-TRP 172, or by one or more T-TRP 170 and one or more NT-TRP172.

The ED 110 is used to connect persons, objects, machines, etc. The ED 110 may be widely used in various scenarios including, for example, cellular communications, device-to-device (D2D), vehicle to everything (V2X), peer-to-peer (P2P), machine-to-machine (M2M), MTC, internet of things (IoT), virtual reality (VR), augmented reality (AR), mixed reality (MR), metaverse, digital twin, industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to but not limited to) as a user equipment/device (UE), a wireless transmit/receive unit (WTRU), a mobile station, a fixed or mobile subscriber unit, a cellular telephone, a station (STA), a MTC device, a personal digital assistant (PDA), a smartphone, a laptop, a computer, a tablet, a wireless sensor, a consumer electronics device, a smart book, a vehicle, a car, a truck, a bus, a train, or an IoT device, wearable devices (such as a watch, a pair of glasses, head mounted equipment, etc.), an industrial device, or an apparatus in (e.g. communication module, modem, or chip) or comprising the foregoing devices, among other possibilities. Future generation EDs 110 may be referred to using other terms. The base station 170a and 170b is a T-TRP and will hereafter be referred to as T-TRP 170. Also shown in FIG. 3, a non-terrestrial (NT) device will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

As shown in FIG. 3, the ED 110 includes at least one processor 210. Only one processor 210 is illustrated to avoid congestion in the drawing. The ED 110 may further include a transmitter 201 and a receiver 203 coupled to one or more antennas 204. Only one antenna 204 is illustrated to avoid congestion in the drawing. One, some, or all of the antennas 204 may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals. The ED 110 may include at least one memory 208. Only the transmitter 201, receiver 203, processor 210, memory 208, and antenna 204 is illustrated for simplicity, but the ED 110 may include one or more other components.

The memory 208 stores instructions. The memory 208 may also store data used, generated, or collected by the ED 110. For example, the memory 208 could store software instructions or modules configured to implement some or all of the functionality and/or embodiments described herein and that are executed by one or more processing unit(s) (e.g., a processor 210). Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the Internet 150 in FIG. 1). The input/output devices or interfaces permit interaction with a user or other devices in the network. Each input/output device or interface includes any suitable structure for providing information to or receiving information from a user, and/or for network interface communications. Suitable structures include, for example, a speaker, microphone, keypad, keyboard, display, touch screen, etc.

The processor 210 performs (or controlling the ED 110 to perform) operations described herein as being performed by the ED 110, as illustrated below and elsewhere in the present disclosure. For example, the processor 210 performs or controls the ED 110 to perform receiving transport blocks (TBs), using a resource for decoding of one of the received TBs, releasing the resource for decoding of another of the received TBs, and/or receiving configuration information configuring a resource. In details, the operation may include those operations related to preparing a transmission for uplink transmission to the NT-TRP 172 and/or the T-TRP 170; those operations related to processing downlink transmissions received from the NT-TRP 172 and/or the T-TRP 170; and those operations related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Processing operations related to processing sidelink transmissions may include operations such as transmit/receive beamforming, modulating/demodulating and encoding/decoding symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by the NT-TRP 172 and/or by the T-TRP 170. In some embodiments, the processor 210 implements the transmit beamforming and/or the receive beamforming based on the indication of beam direction, e.g. beam angle information, received from the T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or from the T-TRP 170.

Although not illustrated, the processor 210 may form part of the transmitter 201 and/or part of the receiver 203. Although not illustrated, the memory 208 may form part of the processor 210.

The processor 210, the processing components of the transmitter 201, and the processing components of the receiver 203 may each be implemented by the same or different one or more processors that are configured to execute instructions stored in a memory (e.g. in the memory 208). Alternatively, some or all of the processor 210, the processing components of the transmitter 201, and the processing components of the receiver 203 may each be implemented using dedicated circuitry, such as a programmed field-programmable gate array (FPGA), an application-specific integrated circuit (ASIC), or a hardware accelerator such as a graphics processing unit (GPU) or an artificial intelligence (AI) accelerator.

In some implementations, the ED 110 may be an apparatus (also called component) for example, communication module, modem, chip, or chipset, it includes at least one processor 210, and an interface or at least one pin. In this scenario, the transmitter 201 and receiver 203 may be replaced by the interface or at least one pin, wherein the interface or at least one pin is to connect the apparatus (e.g., chip) and other apparatus (e.g., chip, memory, or bus). Accordingly, the transmitting information to the NT-TRP 172 and/or the T-TRP 170 and/or another ED 110 may be referred as transmitting information to the interface or at least one pin, or as transmitting information to the NT-TRP 172 and/or the T-TRP 170 and/or another ED 110 via the interface or at least one pin, and receiving information from the NT-TRP 172 and/or the T-TRP 170 and/or another ED 110 may be referred as receiving information from the interface or at least one pin, or as receiving information from the NT-TRP 172 and/or the T-TRP 170 and/or another ED 110 via the interface or at least one pin. The information may include control signaling and/or data.

As shown in FIG. 3, the T-TRP 170 includes at least one processor 260. Only one processor 260 is illustrated to avoid congestion in the drawing. The T-TRP 170 may further include at least one transmitter 252 and at least one receiver 254 coupled to one or more antennas 256. Only one antenna 256 is illustrated to avoid congestion in the drawing. One, some, or all of the antennas 256 may alternatively be panels. The transmitter 252 and the receiver 254 may be integrated as a transceiver. The T-TRP 170 may further include at least one memory 258. The T-TRP 170 may further include scheduler 253. Only the transmitter 252, receiver 254, processor 260, memory 258, antenna 256 and scheduler 253 are illustrated for simplicity, but the T-TRP may include one or more other components.

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a terrestrial node, a terrestrial network device, a terrestrial base station, a base band unit (BBU), a remote radio unit (RRU), an active antenna unit (AAU), a remote radio head (RRH), a central unit (CU), a distributed unit (DU), a positioning node, among other possibilities. The T-TRP 170 may be a macro base station (BS), a pico BS, a relay node, a donor node, or the like, or combinations thereof. The T-TRP 170 may refer to the foregoing devices or refer to apparatus (e.g. a communication module, a modem, or a chip) in the foregoing devices.

In some embodiments, the parts of the T-TRP 170 may be distributed. For example, some of the modules of the T-TRP 170 may be located remote from the equipment that houses the antennas 256 for the T-TRP 170, and may be coupled to the equipment that houses the antennas 256 over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment that houses the antennas 256 of the T-TRP 170. The modules may also be coupled to other T-TRPs. In some embodiments, the T-TRP 170 may actually be a plurality of T-TRPs that are operating together to serve the ED 110, e.g. through the use of coordinated multipoint transmissions.

The processor 260 performs operations including those related to: preparing a transmission for downlink transmission to the ED 110, processing an uplink transmission received from the ED 110, preparing a transmission for backhaul transmission to the T-TRP 170 and/or NT-TRP 172, and processing a transmission received over backhaul from the T-TRP 170 and/or NT-TRP 172. Processing operations related to preparing a transmission for downlink or backhaul transmission may include operations such as encoding, modulating, precoding (e.g. multiple input multiple output (MIMO) precoding), transmit beamforming, and generating symbols for transmission. Processing operations related to processing received transmissions in the uplink or over backhaul may include operations such as receive beamforming, demodulating received symbols, and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates an indication of beam direction which may be scheduled for transmission by a scheduler 253. The processor 260 performs other network-side processing operations described herein, such as determining the location of the ED 110, determining where to deploy the NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Signaling may be transmitted in a physical layer control channel, e.g. a physical downlink control channel (PDCCH), in which case the signaling may be known as dynamic signaling. Signaling transmitted in a downlink physical layer control channel may be known as physical layer signaling such as downlink control information (DCI). Signaling transmitted in an uplink physical layer control channel may be known as physical layer signaling such as uplink control information (UCI). Signaling transmitted in a sidelink physical layer control channel may be known as physical layer signaling such as sidelink control information (SCI). Signaling may be included in a higher-layer (e.g., higher than physical layer) packet transmitted in a physical layer data channel, e.g. in a physical downlink shared channel (PDSCH), in which case the signaling may be known as higher-layer signaling, static signaling, or semi-static signaling. Higher-layer signaling may also refer to radio resource control (RRC) protocol signaling or media access control-control element (MAC-CE) signaling. Signaling may be included in a combination of physical layer signaling and higher layer signaling.

The scheduler 253 may be coupled to the processor 260 or integrated in the processor 260. The scheduler 253 may be included within or operated separately from the T-TRP 170. The scheduler 253 may schedule uplink, downlink, sidelink, and/or backhaul transmissions, including issuing scheduling grants and/or configuring scheduling-free (e.g., “configured grant”) resources.

The memory 258 is configured to store information, and optionally data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252, and the processing components of the receiver 254 may each be implemented by the same or different one or more processors that are configured to execute instructions stored in a memory, e.g. in the memory 258. Alternatively, some or all of the processor 260, the scheduler 253, the processing components of the transmitter 252, and the processing components of the receiver 254 may be implemented using dedicated circuitry, such as a programmed FPGA, a hardware accelerator (e.g., a GPU or AI accelerator), or an ASIC.

When the T-TRP 170 is an apparatus (also called as component, for example, communication module, modem, chip, or chipset in a device), it includes at least one processor, and an interface or at least one pin. In this scenario, the transmitter 252 and receiver 254 may be replaced by the interface or at least one pin, wherein the interface or at least one pin is to connect the apparatus (e.g., chip) and other apparatus (e.g., chip, memory, or bus). Accordingly, the transmitting information to the NT-TRP 172 and/or the T-TRP 170 and/or ED 110 may be referred as transmitting information to the interface or at least one pin, and receiving information from the NT-TRP 172 and/or the T-TRP 170 and/or ED 110 may be referred as receiving information from the interface or at least one pin. The information may include control signaling and/or data.

Although the NT-TRP 172 is illustrated as a drone only as an example, the NT-TRP 172 may be implemented in any suitable non-terrestrial form, such as satellites and high altitude platforms, including international mobile telecommunication base stations and unmanned aerial vehicles, for example. Also, the NT-TRP 172 may be known by other names in some implementations, such as a non-terrestrial node, a non-terrestrial network device, or a non-terrestrial base station.

As shown in FIG. 3, The T-TRP 170 may further include at least one transmitter 252 and at least one receiver 254 coupled to one or more antennas 256. Only one antenna 256 is illustrated to avoid congestion in the drawing. One, some, or all of the antennas 256 may alternatively be panels. The transmitter 252 and the receiver 254 may be integrated as a transceiver. The T-TRP 170 may further include at least one memory 258. The T-TRP 170 may further include scheduler 253. Only the transmitter 252, receiver 254, processor 260, memory 258, antenna 256 and scheduler 253 are illustrated for simplicity, but the T-TRP may include one or more other components.

As shown in FIG. 3, the NT-TRP 172 include at least one processor 276. Only one processor 276 is illustrated to avoid congestion in the drawing. The NT-TRP 172 may include a transmitter 272 and a receiver 274 coupled to one or more antennas 280. Only one antenna 280 is illustrated to avoid congestion in the drawing. One, some, or all of the antennas may alternatively be panels. The transmitter 272 and the receiver 274 may be integrated as a transceiver. The NT-TRP 172 may further include at least one memory 278. The NT-TRP 172 may further include scheduler. Only the transmitter 272, receiver 274, processor 276, memory 278, antenna 280 are illustrated for simplicity, but the NT-TRP may include one or more other components.

The NT-TRP 172 include a processor 276 for performing operations including those related to: preparing a transmission for downlink transmission to the ED 110, processing an uplink transmission received from the ED 110, preparing a transmission for backhaul transmission to T-TRP 170 and/or another NT-TRP 172, and processing a transmission received over backhaul from the T-TRP 170 and/or another NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, demodulating received symbols, and decoding received symbols. In some embodiments, the processor 276 implements the transmit beamforming and/or receive beamforming based on beam direction information received from the T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The memory 278 is configured to store information and optionally data. The memory 278 stores instructions and data used, generated, or collected by the NT-TRP 172. For example, the memory 278 could store software instructions or modules configured to implement some or all of the functionality and/or embodiments described herein and that are executed by the processor 276.

Although not illustrated, the processor 276 may form part of the transmitter 272 and/or part of the receiver 274. Although not illustrated, the memory 278 may form part of the processor 276.

The processor 276, the processing components of the transmitter 272, and the processing components of the receiver 274 may each be implemented by the same or different one or more processors that are configured to execute instructions stored in a memory, e.g. in the memory 278. Alternatively, some or all of the processor 276, the processing components of the transmitter 272, and the processing components of the receiver 274 may be implemented using dedicated circuitry, such as a programmed FPGA, a hardware accelerator (e.g., a GPU or AI accelerator), or an ASIC. In some embodiments, the NT-TRP 172 may actually be a plurality of NT-TRPs that are operating together to serve the ED 110, e.g. through coordinated multipoint transmissions.

When the NT-TRP 172 is an apparatus (e.g. communication module, modem, chip, or chipset) in a device, it includes at least one processor, and an interface or at least one pin. In this scenario, the transmitter 272 and receiver 257 may be replaced by the interface or at least one pin, wherein the interface or at least one pin is to connect the apparatus (e.g., chip) and other apparatus (e.g., chip, memory, or bus). Accordingly, the transmitting information to the T-TRP 170 and/or another NT-TRP 172 and/or ED 110 may be referred as transmitting information to the interface or at least one pin, and receiving information from the T-TRP 170 and/or another NT-TRP 172 and/or ED 110 may be referred as receiving information from the interface or at least one pin. The information may include control signaling and/or data.

Note that “transmit/receive point (TRP)”, as used herein, may refer to a T-TRP or a NT-TRP. A T-TRP may alternatively be called a terrestrial network TRP (“TN TRP”) and a NT-TRP may alternatively be called a non-terrestrial network TRP (“NTN TRP”). The T-TRP 170, the NT-TRP 172, and/or the ED 110 may include other components, but these have been omitted for the sake of clarity.

Note that “signaling”, as used herein, may alternatively be called control signaling, control message, control information, or message for simplicity. Signaling between a BS (e.g., the network node 170) and a terminal or sensing device (e.g., ED 110), or signaling between different terminal or sensing device (e.g., between ED 110i and ED 110j) may be carried in physical layer signaling (also called as dynamic signaling), which is transmitted in a physical layer control channel. For downlink the physical layer signaling may be known as downlink control information (DCI) which is transmitted in a physical downlink control channel (PDCCH). For uplink, the physical layer signaling may be known as uplink control information (UCI) which is transmitted in a physical uplink control channel (PUCCH). For sidelink, signaling between different terminal or sensing device (e.g., between ED 110i and ED 110j) may be known as sidelink control information (SCI) which is transmitted in a physical sidelink control channel (PSCCH). Signaling may be carried in a higher-layer (e.g., higher than physical layer) signaling, which is transmitted in a physical layer data channel, e.g. in a physical downlink shared channel (PDSCH) for downlink signaling, in a physical uplink shared channel (PUSCH) for uplink signaling, and in a physical sidelink shared channel (PSSCH) for sidelink signaling. Higher-layer signaling may also called static signaling, or semi-static signaling. Higher-layer signaling may be radio resource control (RRC) protocol signaling or media access control-control element (MAC-CE) signaling. Signaling may be included in a combination of physical layer signaling and higher layer signaling.

It should be noted that in present disclosure, “information”, when different from “message”, may be carried in one single message, or be carried in more than one separate message.

One or more steps of the embodiment methods provided in this disclosure may be performed by corresponding units or modules, according to FIG. 4. FIG. 4 illustrates units or modules in a device or apparatus, such as in the ED 110, in the T-TRP 170, or in the NT-TRP 172. For example, a signal may be transmitted by a transmitting unit or by a transmitting module. A signal may be received by a receiving unit or by a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be a circuit such as an integrated circuit. Examples of an integrated circuit includes a programmed FPGA, a GPU, or an ASIC. For instance, one or more of the units or modules may be logical such as a logical function performed by a circuit, by a portion of an integrated circuit, or by software instructions executed by a processor. It will be appreciated that where the modules are implemented using software for execution by a processor for example, the modules may be retrieved by a processor, in whole or part as needed, individually or together for processing, in single or multiple instances, and that the modules themselves may include instructions for further deployment and instantiation.

Additional details regarding the EDs 110, the T-TRP 170, and the NT-TRP 172 are known to those of skill in the art. As such, these details are omitted here.

Wireless communications system such as fourth generation (4G) system (for example, Long-Term Evolution (LTE) system), fifth generation (5G) system (for example, a new radio (NR) system) have been deployed to provide various types of applications, such as message, voice, video and other data. In NR, non-terrestrial networks (NTNs) are developed, which may utilize spaceborne vehicles such as satellites (including low earth orbiting (LEO) satellites, medium earth orbiting (MEO) satellites, geostationary earth orbiting (GEO) satellites as well as highly elliptical orbiting (HEO) satellites), or airborne vehicles (also called high-altitude platform) such as drones, or aircraft as a base station or relay for communications between different devices. Either the satellites or the drones in NTNs may move at a high-speed relative to devices such as user equipments (UEs) operating within the NTN, which is different from the scenario between UE and ground-based base station. In addition, the distance between the UE and the satellites or the drones is also much longer than the distance between UE and ground-based base station. The present disclosure is aimed at terminal devices such as UEs, IoT devices, cars, etc. The type of network scenarios envisioned may include terrestrial TRPs such as base-stations and/or non-terrestrial TRPs such as drones, balloons, high-altitude platform stations (HAPS), satellites, and any such devices that support radio access technologies such as 5G NR, future 6G or other technologies.

A scenario is assumed where terrestrial TRPs are communicating with non-terrestrial TRPs that are part of a satellite constellation. FIG. 5 illustrates an example of a communication system 500 with T-TRP and NT-TRP in which some example embodiments of the present disclosure may be implemented. In the communication system 500, a satellite constellation comprises a plurality of satellite orbits, such that the earth is always provided with wireless coverage from the satellites. Each satellite orbit may have a plurality of satellites such as satellites or NT-TRPs 505, 510, and 515 in it. Terrestrial TRPs such as T-TRPs 540, 545, 550, 555, 560, and 565 may be connected to the core network 535 through terrestrial Gateways (TN Gateway) such as 525, 530 while satellite constellations may be connected to the core network 535 through dedicated non-terrestrial Gateway (NTN Gateway) 520, as shown in FIG. 5. Devices such as UEs may connect and communicate with a terrestrial TRP 540, 545, 550, 555, 560, or 565 or with a NT-TRP 505, 510, or 515, depending on the conditions of traffic load, radio link quality, congestion, and so on. The NT-TRPs 505, 510, and 515 can be implementations of the NT-TRP 172 in FIGS. 1, 2, and 3. The T-TRPs 540, 545, 550, 555, 560, and 565 can be implementations of the T-TRP 170 in FIGS. 1, 2, and 3.

Another scenario may be envisioned where the satellite constellation effectively acts as the Gateway for terrestrial TRPs on the ground. FIG. 6 illustrates another example of a communication system 600 with T-TRP and NT-TRP in which some example embodiments of the present disclosure may be implemented. In the scenario of the communication system 600, the satellite constellation with satellites 605, 615 effectively acts as the gateway for terrestrial TRPs 630, 635, 640 and 645, 650, 655 on the ground. Satellites 605, 610, and 615 in the satellite constellation communicate with the core network 625 through NTN gateway 620 located on the ground using a wireless link, while the NTN gateway 620 on the ground use a wired link (e.g. fiber optical link) to communicate with the core network 625. Terrestrial TRPs 630, 635, 640 and 645, 650, 655 communicate with satellites 605 and 615 using a wireless link and satellites communicate between each-other using free space optical links, such as using lasers. Devices such as UEs may connect and communicate with a T-TRP 630, 635, 640, 645, 650, or 655 or with a NT-TRP 605, 610, or 615, depending on the conditions of traffic load, radio link quality, congestion, and so on. The NT-TRPs 605, 610, and 615 can be implementations of the NT-TRP 172 in FIGS. 1, 2, and 3. The T-TRPs 630, 635, 640 and 645, 650, 655 can be implementations of the T-TRP 170 in FIGS. 1, 2, and 3.

Another scenario may be envisioned where the non-terrestrial TRPs communicate with terrestrial TRPs through the core network. FIG. 7 illustrates another example of a communication system 700 with T-TRP and NT-TRP in which some example embodiments of the present disclosure may be implemented. In the scenario of the communication system 700, the non-terrestrial TRPs 705, 710, and 715 communicate with terrestrial TRPs 740, 745, 750, 755, 760, and 765 through the core network 735. Non-terrestrial TRPs 705, 710, and 715 may first communicate with dedicated non-terrestrial gateway 720, which then communicate with the core network 735. The core network 735 may then relay the power saving commands from non-terrestrial TRPs 705, 710, and 715 to terrestrial TRPs 740, 745, 750, 755, 760, and 765 via dedicated terrestrial gateways 725 and 730. Devices such as UEs may connect and communicate with a T-TRP 740, 745, 750, 755, 760, or 765 or with a NT-TRPs 705, 710, or 715, depending on the conditions of traffic load, radio link quality, congestion, and so on. The NT-TRPs 705, 710, and 715 can be implementations of the NT-TRP 172 in FIGS. 1, 2, and 3. The T-TRPs 740, 745, 750, 755, 760, and 765 can be implementations of the T-TRP 170 in FIGS. 1, 2, and 3.

In cellular systems such as 5G NR, the UE can receive, detect and measure reference signals such as SS/PBCH blocks and non-zero power channel state information reference signal (NZP-CSI-RS). Such reference signals are based on pseudo random noise (PRN) binary sequences such as Gold sequences and those sequences may be initialized using common or UE-specific scrambling identities. As an example, primary synchronization signal (PSS) and secondary synchronization signal (SSS) sequences are initialized using the physical cell identity (PCI) value, which is a common scrambling identity. NZP-CSI-RS sequences are initialized using UE-specific scrambling identities, which are configured by the network to the UE.

5G NR Rel-17 introduces support for non-terrestrial networks by introducing several enhancements on the timing relationships for the Timing Advance, the reference timing for channel state information (CSI) resources, the transmission timing of DCIs scheduling PUSCH, the transmission timing of Random Access response carried by a physical uplink shared channel (PUSCH), the transmission timing of hybrid automatic repeat request-acknowledgement (HARQ-ACK) on a physical uplink control channel (PUCCH).

In 5G NR Rel-17, NTN support was introduced allowing UEs to support DL/UL communication with satellites using the so-called “bent-pipe” scenario, where a ground station transmits signals towards satellites in space, and satellites reflect signals back to UEs on the ground. Dedicated signaling related to NTN was introduced in order to assist UEs with NTN operation. Higher-layer signaling such as RRC introduces signaling satellite ephemeris, satellite position, satellite signal polarization, timing advance offsets, satellite System Information Block (SIB), satellite epochs in order to support NTN operation. Other features that were introduced were the extension of HARQ processes to 32 in order to accommodate for large propagation delay scenarios and the disabling of HARQ-ACK feedback.

5G NR Rel-17 also introduces a solution combining closed-loop and open-loop Timing Advance compensation, where the closed-loop part is controlled by the network and the open-loop part is carried out by the UE. The compensation from the UE may be based on the knowledge of the satellite's ephemeris (e.g. parameters such as the satellite's orbital angles).

5G NR Rel-17 supports so-called “bent-pipe” scenarios, i.e. the base-station is located behind a NTN gateway on the ground, the NTN gateway sends a transmission towards the satellite (this link is called the “feeder” link) and the satellite transmits the transmission towards UEs on the ground (this link is called the “service” link).

FIG. 8 illustrates an example of a communication system 800 with T-TRP and NT-TRP in which some example embodiments of the present disclosure may be implemented. In the communication system 800, NT-TRPs 805 and 810 in the satellite constellation communicate with the core network 820 through NTN gateway 815 located on the ground using a wireless link. The T-TRP 825 is located behind a NTN gateway 815 on the ground. The NTN gateway 815 sends a transmission towards the NT-TRPs 805 and 810 using a “feeder” link and the NT-TRP 805 or 810 transmits the transmission towards UEs on the ground using a “service” link. The NT-TRPs 805 and 810 can be an implementation of the NT-TRP 172 in FIGS. 1, 2, and 3. The T-TRP 825 can be implementations of the T-TRP 170 in FIGS. 1, 2, and 3.

In 5G NR Rel-18, NTN support was further enhanced to introduce coverage enhancements for NTN, network-verified UE location, as well as support TN to NTN and NTN to NTN mobility scenarios. Satellites transmit multiple beams towards the ground and each beam may be associated with a given “physical cell identity”. In addition, the satellites transmit beams in a “fixed” manner, where “fixed” means that the satellite isn't steering its beams towards a given direction, instead the beams “slide” on the surface of Earth and thus appear to be “moving” from the perspective of devices on the ground.

The support introduced in 5G NR Rel-17 for NTN is based on a non-transparent design in the sense that every satellite is effectively seen by devices such as UEs, IoT devices, cars, etc., as a serving cell. Devices are also made aware of the satellite's ephemeris as well as the satellite's position at any given time as the satellite explicitly broadcasts it within System Information Block 19 (SIB19), which is transmitted by satellites in order to assist devices such as UEs with assistance information for NTN access (i.e., the UEs access to the NTN and to be served by the NTN). This results in a non-transparent radio access design which prevents smooth integration of transmit diversity schemes, multi-TRP transmission schemes and distributed satellite systems.

In the case of Low Earth Orbit (LEO) NTN access, satellites are constantly in movement and therefore are in line-of-sight to devices on the ground for a limited amount of time. Taking the Starlink constellation as an example, a LEO satellite may be in line-of-sight of a given device on the ground for a duration in order of several minutes. As a result, any information that the satellite transmits or broadcasts to devices on the ground becomes outdated within a few minutes and constantly needs to be updated in order for the satellite communication to be working (due to ever changing Timing Advance for Uplink synchronization, and the need to (re-)acquire Downlink synchronization). This results in high signaling overhead between satellites and devices on the ground just to keep the communication link operational.

LEO satellites use the fixed-beam model in order to transmit signals and channels towards devices on the ground. This results in satellite beams “sliding” across the surface of Earth, which triggers mobility and handover procedures whenever devices are located at the edge between two beams. Mobility and handover procedures may cause delays and interruptions as the RRC connection needs to be re-established upon entering the target cell, which hurts the overall user experience.

In view of the above, some embodiments of the disclosure provide a solution of beam activation and switching in NTN. By communicating with a NTN device using a beam of one of the indicated angular direction(s), the terminal device does not need to access a cell of a NTN device for communication which moves along its orbit and handover to another cell of another NTN device for communication when the previous NTN device moves away. The power consumption and complexity for the terminal device to communicate with NTN devices may be reduced and communication quality of the terminal device with the non-terrestrial network may be improved.

FIG. 9 illustrates an example signaling chart of a communication process 900 in which some example embodiments of the present disclosure may be implemented. The terminal device 910 can be an implementation of the ED 110 in FIGS. 1, 2, and 3. The NTN device 972 can be an implementation of the NT-TRP 172 in FIGS. 1, 2, and 3, or NT-TRPs 505-515 in FIG. 5, or NT-TRPs 605-615 in FIG. 6, or NT-TRPs 705-715 in FIG. 7, or NT-TRPs 805-810 in FIG. 8. The skilled in the art can understand that the terminal device 910 can be replaced with other device, such as a relay device in the coverage area of the first network device 905.

In the communication process 900, the terminal device 910 obtains an indication 902 of at least one angular direction. For example, the NTN device 972 may transmit 901 the indication 902 of the at least one angular direction to the terminal device 910. Alternatively, the terminal device 910 may receive the indication 902 of the at least one angular direction from other devices, e.g., another NTN device different from the NTN device 972 or a TN device (e.g., a base station on the earth) or a terminal device nearby. The terminal device 910 communicates signals with the NTN device 972 using one of at least one beam associated with the at least one angular direction. For example, the terminal device 910 may receive signals from the NTN device 972 using a reception beam associated with one of the at least one angular direction. In another example, the terminal device 910 may transmit signals to the NTN device 972 using a transmission beam associated with one of the at least one angular direction.

In some embodiments, an indication of an angular direction may be referred to as a beam angular indication (BAI). It should be understood that the term “beam angular indication” is merely for illustration, other terms are also possible. A BAI may be defined as a quantized indication of an angular direction. The angular direction may be given in e.g. the Azimuth domain, in the Zenith domain, in the Elevation domain. This quantized indication may indicate an angular direction towards which the terminal device is expected to steer its reception and/or transmission beam, resulting in e.g. the boresight of the reception and/or transmission beam pointing in the angular direction indicated by the BAI. Throughout the present disclosure, the terms “angular” and “angle” may be used exchangeable.

In some embodiments, the terminal device 910 may receive an association between one or more indications of one or more angular directions and one or more beams. For example, the NTN device 972 may transmit the association to the terminal device 910. Alternatively, the terminal device 910 may receive the association from other devices, e.g., another NTN device different from the NTN device 972 or a TN device (e.g., a base station on the earth) or a terminal device nearby. The one or more angular directions may include the at least one angular direction and the one or more beams may include the at least one beam. For example, the terminal device 910 may receive an association between multiple BAIs and multiple beams. Upon receiving an indication of at least one BAI among the multiple BAIs, the terminal device 910 may be aware that at least one beam associated with the at least one BAI can be used for communication with the NTN. The terminal device 910 may determine to use one of the at least one beam for signal transmission and/or reception.

In some embodiments, the terminal device 910 may activate the at least one beam associated with the at least one angular direction and deactivate remaining beams associated with remaining angular directions different from the at least one angular direction. The one or more angular directions may include the remaining angular directions and the one or more beams may include the remaining beams. In other words, the terminal device 910 may be configured with a set of angular directions, and a subset among the configured angular directions may be activated. The terminal device 910 may steer its reception and/or transmission beam to one of the activated angular directions when communicating with the NTN device 972. It should be noted that in the present disclosure, the term “subset” may indicate a part or all of the whole set.

In some embodiments, the indication of the association may be carried in a radio resource control (RRC) signaling. The indication of the at least one angular direction may be carried in a media access control (MAC) control element (CE) signaling. Alternatively, the indication of the at least one angular direction may be carried in a radio resource control (RRC) signaling. Alternatively, the indication of the at least one angular direction may be carried in downlink control information (DCI). In this way, the angular directions may be pre-configured and dynamically or semi-statically activated.

In some embodiments, the indication of the at least one angular direction indicates a plurality of angular directions in an order. The order indicates a priority of using the plurality of angular directions. For example, the terminal device 910 may receive an indication of a plurality of angular directions in an order. The terminal device 910 may measure reference signals using a beam associated with an angular direction in the first order among the plurality angular directions and determine whether the link quality is applicable for communication. If not, the terminal device 910 may switch to a beam associated with an angular direction in the second order.

In some embodiments, one of the at least one angular direction is indicative of a direction applied in an Azimuth domain. Alternatively or additionally, one of the at least one angular direction is indicative of a direction applied in a Zenith domain. Alternatively or additionally, one of the at least one angular direction is indicative of a direction applied in an Elevation domain. In this way, the spatial direction of a beam may be determined based on an indication of an angular direction associated with the beam.

In some embodiments, the at least one angular direction may include a plurality of angular directions. The plurality of angular directions may include a first angular direction and a second angular direction. The at least one beam may include a first beam is associated with the first angular direction and a second beam associated with the second angular direction. When communicating with the NTN device 972, the terminal device 910 may receive the signals from the NTN device 972 using the first beam and determine a quality degradation associated with the signals received using the first beam. The first beam is associated with an outermost angular direction in a cone region constrained by the plurality of angular directions. The terminal device 910 may perform a beam switching from the first beam to the second beam. For example, if a plurality of angular directions are activated, a cone region is constrained by the plurality of angular directions. If the NTN device 972 moves away from the cone region, the terminal device 910 may switch its beam towards another angular direction to communicate with another NTN device within the cone region.

In some embodiments, the terminal device 910 may transmit capability information of the terminal device 910. The cone region is associated with the capability information. In other words, the activated angular directions may be associated with the capability of the terminal device 910. In this way, the communication quality may be improved and the power consumption may be reduced.

In some embodiments, when determining the quality degradation associated with the signals, the terminal device 910 may determine that a reference signal received power (RSRP) of the signals is below a first threshold for a first duration. Alternatively or additionally, when determining the quality degradation associated with the signals, the terminal device 910 may determine that a reference signal received quality (RSRQ) of the signals is below a second threshold for a second duration. Alternatively or additionally, when determining the quality degradation associated with the signals, the terminal device 910 may determine that a signal to interference and noise ratio (SINR) of the signals is below a third threshold for a third duration. Alternatively or additionally, when determining the quality degradation associated with the signals, the terminal device 910 may determine that the signals are received using the first beam for a fourth duration.

In some embodiments, the terminal device 910 may receive a configuration of triggering the beam switching. For example, the NTN device 972 may transmit the configuration of triggering the beam switching to the terminal device 910. Alternatively, the terminal device 910 may receive the configuration of triggering the beam switching from other devices, e.g., another NTN device different from the NTN device 972 or a TN device (e.g., a base station on the earth) or a terminal device nearby. The configuration of triggering the beam switching may include the first threshold and the first duration for the RSRP. Alternatively or additionally, the configuration of triggering the beam switching may include the second threshold and the second duration for the RSRQ. Alternatively or additionally, the configuration of triggering the beam switching may include the third threshold and the third duration for the SINR. Alternatively or additionally, the configuration of triggering the beam switching may include the fourth duration for the outermost angular direction.

In some embodiments, the terminal device 910 may receive a second indication indicating one of the at least one angular direction. When communicating with the NTN device 972, the terminal device 910 may transmit or receive the signals using one beam associated with the one of the at least one angular direction. The one beam belongs to the at least one beam. In other words, the terminal device 910 may be informed of steering its beam towards which one among the activated angular directions. The NTN device 972 may transmit the second indication to the terminal device 910. Alternatively, the terminal device 910 may receive the second indication from other devices, e.g., another NTN device different from the NTN device 972 or a TN device (e.g., a base station on the earth) or a terminal device nearby.

In some embodiments, the terminal device 910 may receive an indication of one of the at least one angular direction and an indication of a correction on the one of the at least one angular direction. When communicating with the NTN device 972, the terminal device 910 may transmit or receive the signals using one beam associated with the one of the at least one angular direction applied with the correction, wherein the one beam belongs to the at least one beam. In this way, even though only a limited number of angular directions are configured or activated, the terminal device may steer its beam towards a suitable spatial direction not limited to the configured or activated angular directions, thus improving the communication quality with the NTN. The NTN device 972 may transmit the indication of the angular direction and the indication of the correction on the angular direction to the terminal device 910. Alternatively, the terminal device 910 may receive the indication of the angular direction and the indication of the correction on the angular direction from other devices, e.g., another NTN device different from the NTN device 972 or a TN device (e.g., a base station on the earth) or a terminal device nearby.

In some embodiments, when communicating with the NTN device 972, the terminal device 910 may detect reference signals using the at least one beam and determine a beam with a strongest reference signal strength based on the detected reference signals, wherein the beam belongs to the at least one beam. The terminal device 910 may transmit/receive the signals to/from the NTN device 972 using the beam with the strongest reference signal strength. In this way, the communication quality with the NTN may be improved.

In some embodiments, the at least one angular direction comprises a plurality of angular directions. The terminal device 910 may receive an indication of a default angular direction. The default angular direction belongs to the plurality of angular directions. For example, the NTN device 972 may transmit the indication of the default angular direction to the terminal device 910. Alternatively, the terminal device 910 may receive the indication of the default angular direction from other devices, e.g., another NTN device different from the NTN device 972 or a TN device (e.g., a base station on the earth) or a terminal device nearby. The terminal device 910 may perform a beam switching to a beam associated with the default angular direction if a quality degradation associated with the signals received using a first beam among the plurality of angular directions, wherein the first beam is associated with an outermost angular direction in a cone region constrained by the plurality of angular directions. For example, when the NTN device 972 moves away from the cone region of the terminal device 910, the terminal device 910 may switch its beam towards another NTN device that is located at the default angular direction. Alternatively, the terminal device 910 may perform a beam switching to a beam associated with the default angular direction upon a state transition of the terminal device 910 from an RRC connected state to a power sleep mode. The terminal device 910 may use the default angular direction for the whole duration while the terminal device 910 is in a power sleep mode. Alternatively, the terminal device 910 may perform a beam switching to a beam associated with the default angular direction upon a state transition of the terminal device 910 from an RRC connected state to an idle mode. The terminal device 910 may use the default angular direction for the whole duration while the terminal device 910 is in an idle mode.

The power sleep mode is the mode where the terrestrial TRP may perform no communication or sensing functions towards the terminal devices 910 (such as EDs) within its coverage area, the terrestrial TRP may be no longer transmitting any kind of physical layer signal or channel towards any terminal device 910 (e.g. UEs, cars, Internet of Things type of devices, robots, etc.), the terrestrial TRP may also no longer detecting and measuring any physical layer signals transmitted by any terminal device 910 or detecting and decoding any physical layer channels transmitted by any terminal device 910. This allows the terrestrial TRP to significantly reduce its power consumption in order to meet the goals such as carbon neutrality goals or energy consumption goals. In the power sleep mode, the terrestrial TRP may perform monitoring power consumption (PC) indication(s) (or referred as wake-up indication(s)) from one or more non-terrestrial TRPs. In some examples, terrestrial TRPs in power sleep mode may only perform the function of monitoring wake-up indications transmitted from other devices, for example, terrestrial TRPs do not transmit any signal/channel nor receive any signal/channel towards UEs, cars, robots and other such IoT devices on the ground as terrestrial TRPs only perform basic function necessary for further receiving the power consumption indications, such as NT-TRP searching and synchronization. It is noted that the “power sleep” mode may also be called “sleep” mode, “low power” mode, “extreme low power” mode or other such denominations, i.e., the name used in the present disclosure shall not limit the scope of the present disclosure.

In some embodiments, the default angular direction is associated with a time and/or frequency domain pattern indicative of resources for communicating the signals. For example, the default angular direction may be associated with a so-called “Beam Hopping” pattern, where the beam hopping pattern may be configured as a time and/or frequency domain pattern indicating in which resources beams may be transmitted on.

Hereinbefore, some embodiments of the beam activation and switching in non-terrestrial networks are described in general terms. Hereinafter, some example implementations of the beam activation and switching in terrestrial/non-terrestrial networks will be further detailed referring to different example implementations.

In a first example implementation, different BAIs may be “activated” through the reception of “activation” commands. Examples of activation commands include MAC-CE-based activation. The principle of “activating” a BAI is that a configured BAI may be “activated” by an “activation” command. This may be done by e.g., setting a configured BAI to an “active” state, therefore the BAI may be considered in “active” state. An activation command may activate one Zenith BAI or multiple Zenith BAIs.

In some embodiments, there may be a coverage area on the ground and some devices, e.g., UEs, are within this coverage area. FIG. 10 illustrates an example of a coverage area 1000 on the ground in which some example embodiments of the present disclosure may be implemented. For example, four UEs are located within the coverage area 1000. The UEs within the coverage area 1000 may be connected to the network, i.e., the UEs may have an RRC connection with the network and are in connected mode. Alternatively, the UEs within the coverage area 1000 may not be connected to the network, i.e. the UEs may not have an RRC connection with the network and are in idle mode or in inactive mode. Alternatively, UEs may be in a power sleep mode that is associated with having an RRC connection (for a connected mode) or UEs may be in a power sleep mode that is not associated with having an RRC connection (for a idle mode or an inactive mode).

In order to connect with a non-terrestrial system, e.g., a satellite mega-constellation, the UEs need to steer their beams towards the sky. However there may be lots of non-terrestrial TRPs (NT-TRPs), e.g. satellites that are in line-of-sight of the UEs. Therefore, there may be potentially lots of non-terrestrial TRPs that a UE could establish a connection with.

In some embodiments, in order to assist a UE with establishing a connection with a NT-TRP, the UE may have to generate a transmission/reception beam towards that NT-TRP (in order to e.g. receive reference signals transmitted by that NT-TRP). When the UEs are in connected mode, they may be provided with a table of BAIs using higher-layer signaling (e.g. RRC) in the Zenith domain. An example of such a Zenith BAI table may be as Table 1.

TABLE 1
BAI table in Zenith domain

| | | | | | | | |
|---|---|---|---|---|---|---|---|
| Zenith Angle | −30 | −20 | −10 | 0 | 10 | 20 | 30 |
| [degrees] | | | | | | | |
| BAI | 000 | 001 | 010 | 011 | 100 | 101 | 110 |

As shown in Table 1, each Zenith angle corresponds to an absolute angular direction in e.g. degrees and may be interpreted as the angular direction in which the UE may steer its spatial reception beam such that the boresight of the spatial reception beam is pointing in that angular direction. It may be assumed that 0 degrees in the Zenith domain corresponds to the UE's transmission/reception beam pointing vertically towards the sky. Each angular direction is associated with a BAI provided as a 3-bit codeword. In this example, codewords have a 3-bit width because the Zenith BAI table contains 7 entries. Other examples of Zenith BAI tables with more or less number of entries may be considered or contemplated. The Zenith BAI table may contain one or more entries where each entry contains a 3-bit codeword. The UE may use any one or more entries within the Zenith BAI table in order to steer its spatial reception beam in the direction of any one or more entries. The UE may also use a default Zenith BAI for its spatial transmission beam to transmit UL signals and/or channels.

In the example of Table 1, the UE is configured with a Zenith BAI table containing seven entries. In some embodiments, the network may use MAC-CE commands in order to activate a given Zenith BAI within the table. An example of a MAC-CE command for activating a Zenith BAI is provided in Table 2. As shown in Table 2, the MAC-CE command may contain a Zenith BAI with a bit-width of 3 bits and its value is set to ‘011’ to indicate to the UE that the UE is supposed to steer its transmission/reception beam such that the boresight's angle may be at 0 degrees in the Zenith domain.

TABLE 2
MAC-CE command for activating one Zenith BAI

| | |
|---|---|
| MAC-CE command type [5 bits] | Zenith BAI = 011 [3 bits] |

In some embodiments, “activation” for a given Zenith BAI may be considered to happen when the MAC-CE command is received, detected and decoded. Similarly, if a configured BAI is not indicated in the MAC-CE command, then it may be considered that those configured BAIs may have been deactivated. Throughout the present disclosure, the expression “activation of a beam associated with an angular direction” may be interchangeably used with the expression “activation of a BAI”.

By activating BAIs in the Zenith domain, devices on the ground may connect with multiple NT-TRPs operating as part of a non-terrestrial system e.g. a satellite constellation. Especially in the case of so-called “mega constellations”, devices on the ground may be able to receive, detect and measure reference signals from more than one NT-TRP, therefore devices on the ground would benefit in terms of NT-TRP diversity. In addition, such diversity in NT-TRPs is beneficial to the non-terrestrial system as it would prevent “jamming” individual NT-TRPs. Such “jamming” may happen in particular in higher layers such as at the Internet Protocol (IP) layer and above, where a given NT-TRP may be seen as the “best” NT-TRP to serve a given area and all traffic is sent towards that NT-TRP, resulting in this NT-TRP getting overloaded and therefore “jammed”. Allowing devices on the ground to be served by a plurality of NT-TRPs prevents such jamming situations from occurring.

Although Table 2 provides an example of “activation” for a given Zenith BAI, the MAC-CE command may be implemented in various manners. For example, the MAC-CE command may contain other fields, e.g., the MAC-CE command type, which may indicate to the UE the type of the MAC-CE command. For example, the MAC-CE command type may be indicative of at least one of a Zenith BAI activation, a Zenith BAI deactivation, an Azimuth BAI activation, or an Azimuth BAI deactivation. In the example in Table 2, the MAC-CE command activates only one transmission/reception beam in the Zenith domain. In some other examples, a MAC-CE command may activate one or more BAIs. An example of such a MAC-CE is provided in Table 3.

TABLE 3
MAC-CE command for activating multiple Zenith BAIs

| | | | |
|---|---|---|---|
| MAC-CE | Zenith BAI = | Zenith BAI = | Zenith BAI = |
| command | 011 [3 bits] | 010 [3 bits] | 100 [3 bits] |
| type [5 bits] | | | |

As shown in Table 3, the MAC-CE command may be transmitted by a NT-TRP. Subject to the UE's capability, the MAC-CE command may contain one or more Zenith BAIs. The Zenith BAIs in the MAC-CE command may each have a bit-width of 3 bits and their values are set to ‘011’, ‘010’ and ‘100’ respectively to indicate to the UE that the UE is supposed to steer its transmission/reception beam such that the boresight's angle may be 0 degrees (Zenith BAI=011), −10 degrees (Zenith BAI=010) or 10 degrees (Zenith BAI=100) in the Zenith domain.

In some embodiments, the ordering of the values may indicate an implicit hierarchy in the sense that the UE would steer its transmission/reception beam at 0 degrees in the Zenith domain first; if the UE fails to receive, detect and measure any reference signals using this beam, then the UE would steer its transmission/reception beam at −10 degrees in the Zenith domain; if the UE still fails to receive, detect and measure any reference signals using this beam, then the UE would steer its transmission/reception beam at 10 degrees in the Zenith domain.

FIG. 11 illustrates an example 1100 of a scenario where three beam angular directions are activated for a UE to communicate with NT-TRPs in which some example embodiments of the present disclosure may be implemented. In the example 1100, the NT-TRPs 1105, 1110 and 1115 may provide network service for UEs within the coverage area 1120. The NT-TRPs 1105, 1110 and 1115 can be implementations of the NT-TRP 172 in FIGS. 1, 2, and 3. The UEs within the coverage area 1120 may be configured with multiple Zenith BAIs. The UE receives an indication of activating Zenith BAIs 010, 011 and 100 among the configured Zenith BAIs. Beams 1125, 1130 and 1135 are associated with angular directions (i.e., −10 degrees, 0 degrees, 10 degrees in Zenith domain) indicated by the activated Zenith BAIs 010, 011 and 100, respectively. The beams 1125, 1130 and 1135 are activated and can be used by the UEs within the coverage area 1120 to communicate with the NT-TRPs 1105, 1110 and 1115.

In this way, multiple BAIs may be activated, thus allowing UEs to receive, detect and measure reference signals from multiple NT-TRPs located in different directions. Similarly, activating multiple BAIs may allow UEs to receive, detect and decode physical layer downlink control and data transmissions (e.g. PDCCH and PDSCH respectively) from multiple NT-TRPs located in different directions. Thereby, “transmit diversity” or “NT-TRP diversity” may be enabled such that UEs may be able to receive reference signals or downlink transmissions from different NT-TRPs. Such schemes may prevent “jamming” any given NT-TRP from a routing perspective as there may be more than one NT-TRP providing coverage to a given UE.

In addition, activating multiple BAIs may allow the network to constrain the directions from which UEs attempt to receive, detect and measure reference signals. Alternatively or additionally, activating multiple BAIs may allow the network to constrain the directions from which UEs attempt to receive, detect and decode physical layer downlink transmissions, e.g., PDCCH/PDSCH. NT-TRPs (such as satellites) may move along their orbits, as may be the case in e.g. Low Earth Orbit (LEO) constellations. Instead of continuously following a given NT-TRP, UEs simply attempt to detect transmissions coming from the direction indicated by the Zenith BAI, irrespective of the NT-TRP's movement. Since all NT-TRPs are assumed to be located on the same orbit, the UE may assume that the Timing Advance wouldn't change and the downlink timing reference wouldn't change.

It should be understood that the bits size shown in Tables 1, 2 and 3 are merely for illustration. Other bit sizes are also possible. It should be further understood that embodiment of the present disclosure may be equally applicable in the uplink. For example, the UE may transmit reference signals or physical layer transmissions (e.g. PUCCH/PUSCH) using the activated Zenith BAI.

In some embodiments, the BAI may be a BAI in the Azimuth domain, i.e. a beam pointing in a given direction in the horizontal domain. In some embodiments, the UE may be configured with a Zenith BAI table and a Azimuth BAI table. In some embodiments, the MAC-CE activation command may activate an Azimuth BAI. In some embodiments, the MAC-CE activation command may activate an Azimuth BAI and a Zenith BAI simultaneously, indicating to the UE to steer its beam towards the angular direction indicated by both the Azimuth BAI and the Zenith BAI. In some embodiments, subject to the UE's capability, the MAC-CE activation command may activate more than one Azimuth BAI and more than one Zenith BAI, indicating to the UE to steer its first beam towards the angular direction indicated by the first Azimuth BAI and the first Zenith BAI, then its second beam towards the angular direction indicated by the second Azimuth BAI and the second Zenith BAI, and so on.

In this way, a user-centric scheme for communications in NTN may be designed. The UEs does not need to access a specific cell of a specific NTN device for network connection and thus does not need to handover to another cell frequently due to the movement of the NTN devices. The power consumption may be reduced and the communication quality may be improved.

A second example implementation may be similar with the first example implementation and only different in that examples of activation commands include DCI-based activation. Details of the first example implementation may also apply to the second example implementation, thus details of the second example implementation are omitted here.

In one possible example, a DCI format may include a “Zenith BAI” field with a bit-width of e.g. 3 bits and its value may indicate the Zenith BAI. The DCI format may thus activate and/or indicate the UE to use one transmission/reception beam in the Zenith domain by indicating one value of a Zenith BAI. For example, the UE may be configured with a Zenith BAI table (e.g., Table 1). The network may use DCI-based activation commands in order to activate a given Zenith BAI within the table. An example of such a DCI format is shown below (other fields are not shown):

```
DCI_format = {
  ...
  ZenithBAI = {011},
  ...
}
```

The DCI format may contain a Zenith BAI with a bit-width of 3 bits and its value is set to ‘011’ to indicate to the UE that the UE is supposed to steer its transmission/reception beam such that the boresight's angle may be at 0 degrees in the Zenith domain. The DCI format may further contain other fields (not shown).

In another possible example, after receiving a MAC CE activation command to activate multiple Zenith BAIs, the UE may further receive a DCI format to indicate which one of multiple activated BAIs may be used by the UE. For example, the UE has received a MAC-CE command (e.g., a MAC CE command shown in Table 3) to active three Zenith BAIs. Then, the UE may further receive a DCI format indicating which of the activated Zenith BAIs is to be used by the UE, an example of such a DCI format is shown below:

```
DCI_format = {
  ...
  ZenithBAI = {00},
  ...
}
```

In this example, the MAC-CE command includes three BAIs to be activated, thus, 2 bits could be used in the DCI format to indicate which one of the three activated BAIs is to be actually used by the UE. For example, the DCI format may include a ‘ZenithBAI’ field set to the value of ‘00’, which indicates to the UE that the UE should use the 1st activated Zenith BAI, which is the Zenith BAI with the value ‘011’ in Table 3. Similarly, the DCI format may include a ‘ZenithBAI’ field set to the value of ‘01’, which would indicate to the UE that the UE should use the 2nd activated Zenith BAI, which is the Zenith BAI with the value ‘010’ in Table 3. Similarly, the DCI format may include a ‘ZenithBAI’ field set to the value of ‘10’, which would indicate to the UE that the UE should use the 3rd activated Zenith BAI, which is the Zenith BAI with the value ‘100’ in Table 3. Other examples and mappings may be contemplated for the codewords of the ‘ZenithBAI’ field.

By indicating which BAI in the Zenith domain to use, devices on the ground may connect with multiple NT-TRPs operating as part of a non-terrestrial system e.g. a satellite constellation. Especially in the case of so-called “mega constellations”, devices on the ground may be able to receive, detect and measure reference signals from more than one NT-TRP, therefore devices on the ground would be benefit in terms of NT-TRP diversity. In addition, such diversity in NT-TRPs is beneficial to the non-terrestrial system as it would prevent “jamming” individual NT-TRPs. Such “jamming” may happen in particular in higher layers such as at the Internet Protocol (IP) layer and above, where a given NT-TRP may be seen as the “best” NT-TRP to serve a given area and all traffic is sent towards that NT-TRP, resulting in this NT-TRP getting overloaded and therefore “jammed”. Allowing devices on the ground to be served by a plurality of NT-TRPs prevents such jamming situations from occurring.

In some embodiments, the DCI format may further include a ‘ZenithBAICorrection’ field which may indicate to the UE that it should apply a correction to a currently activated Zenith BAI. An example of such a DCI format is provided below:

```
DCI_format = {
  ...
  ZenithBAI = {00},
  ZenithBAICorrection = {0011}
  ...
}
```

The DCI format may include a ‘ZenithBAICorrection’ field, which may have a bit-width of e.g. 4 bits. The value of the ‘ZenithBAICorrection’ field may indicate a corrective factor in e.g. units of 0.25 degrees. If the ‘ZenithBAICorrection’ field is set to the value of ‘0011’, this may indicate to the UE that the UE should apply a correction of 0.75 degrees on the activated Zenith BAI, which results in the beam being steered towards an angular direction on 0.75 degrees. Other examples and mappings may be contemplated.

In some embodiments, the methods and mechanisms mentioned in the present disclosure may be applicable to devices that are in idle mode or in inactive mode (or in a power sleep mode that is associated with sleeping or deep sleeping), for e.g. system information (SI) reception or paging reception.

By apply a correction on the angular direction towards which the UE should steer its beam, the communication quality may be improved. By introducing the correction on the BAI, a small number of entries needs to be configured in the BAI table, which simplifies the configuration of the BAI table and the determination procedure of the BAI to be used.

In a third example implementation, the feature of BAI switching may be introduced, and in particular the switching of BAIs in the Zenith domain may be introduced. As the NT-TRP moves along its orbit, devices on the ground (e.g. UEs) might perceive changes where different beams need to be used in order to e.g. better receive, detect and measure reference signals from this NT-TRP. Such beam switching might occur due to the movement of the NT-TRP along its orbit, thus resulting in high power consumption, high complexity and low communication quality. In the third example implementation, a “visibility cone” may act as a constraint on the Zenith BAIs that a UE may be configured with. When a NT-TRP moves away from the UE's visibility cone, the UE may switch its beam towards another NT-TRP that is located within the UE's visibility cone.

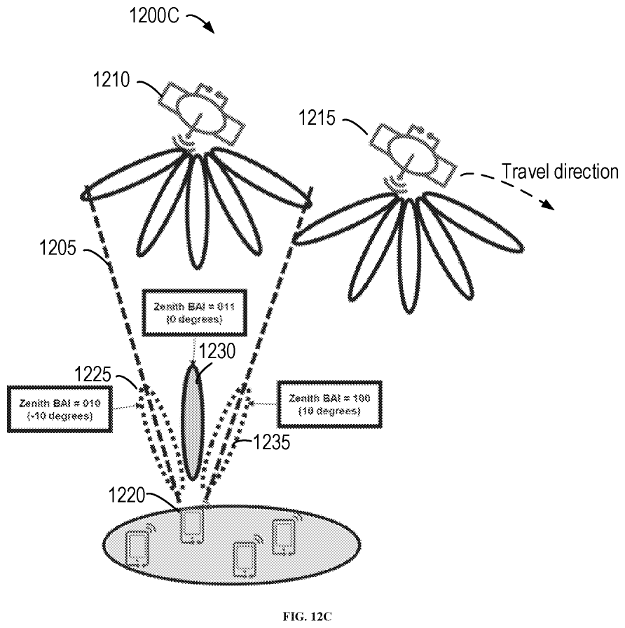

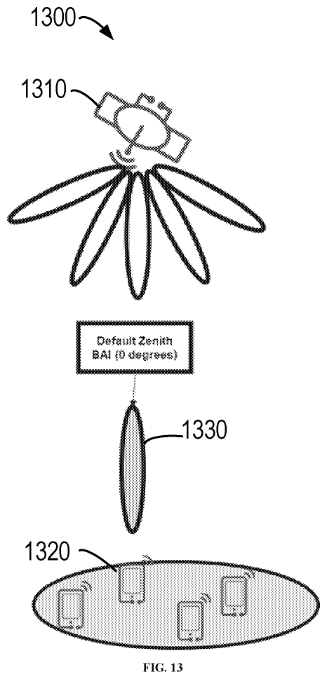

In some embodiments, devices on the ground (e.g. UEs) may be in connected mode, i.e. that they have established e.g. an RRC connection with the non-terrestrial network. NT-TRPs, e.g., satellites, may transmit multiple beams such that they are able to provide coverage to different coverage areas. FIG. 12A illustrates an example 1200A of a NT-TRP transmitting multiple beams in which some example embodiments of the present disclosure may be implemented. In the example 1200A, the NT-TRP 1215 may transmit up to e.g., 30 beams. It should be understood that examples of NT-TRPs that may be able to generate more or less than 30 beams may be contemplated. The NT-TRP 1215 can be an implementation of the NT-TRP 172 in FIGS. 1, 2, and 3.

In some embodiments, depending on the Zenith BAI table that may be configured at e.g. the UE and depending on the Zenith BAI(s) that may have been activated at the UE, such beam switching may happen in particular when a NT-TRP moves away from the UE.

FIG. 12B illustrates an example 1200B of triggering of a BAI switching based on a visibility cone in which some example embodiments of the present disclosure may be implemented. In the example 1200B, the NT-TRP 1215 may transmit multiple beams to provide different coverage areas on the ground. The NT-TRP 1215 can be an implementation of the NT-TRP 172 in FIGS. 1, 2, and 3. Beams 1225, 1230 and 1235 are associated with angular directions (i.e., −10 degrees, 0 degrees, 10 degrees in Zenith domain) indicated by the activated Zenith BAIs 010, 011 and 100, respectively. The beams 1225, 1230 and 1235 are activated and can be used by the UE 1220 to communicate with NT-TRPs.

In the example 1200B, the UE 1220 may have been using the beam 1235 corresponding to the Zenith BAI at 10 degrees to receive, detect and measure reference signals from the NT-TRP 1215. Alternatively or additionally, the UE 1220 may have been using the beam 1235 to receive, detect and decode physical layer transmissions (e.g. PDCCH/PDSCH) from the NT-TRP 1215. Since the NT-TRP 1215 is moving along its orbit, its coverage area may move away from the UE's location and the UE may experience some degradation in its link quality. The “visibility cone” 1205 may refer to the area located between the angular directions corresponding to −10 degrees (i.e. Zenith BAI=010) and 10 degrees (i.e. Zenith BAI=100). When the NT-TRP 1215 exits the visibility cone of the UE 1220, this may constitute a beam switching trigger for the UE 1220.

As a first example, the UE 1220 may use the degradation in the reference signal received power (RSRP) as a trigger for beam switching. As a second example, the UE may use the degradation in the signal to interference and noise ratio (SINR) as a trigger for beam switching. As a third example, the UE 1220 may use the change in the angular direction of the NT-TRP as a trigger for beam switching. In some implementations, a combination of one or more of e.g. RSRP-based trigger, SINR-based trigger, Zenith-angle-based trigger may be used in order to trigger Zenith beam-switching. The UE 1220 may use one or more of the above approaches or other approaches in order to determine whether to switch the angular direction of its beam or not. An example of the higher-layer signaling (e.g. RRC) corresponding to beam switching based on RSRP is provided below:

```
BeamSwitchTriggerConfig = {
  beamSwitchRSRP = {
    beamSwitchThreshold = {−110dBm},
    hysteresis = {3dB},
    timeToTrigger = {10ms}
  }
}
```

The above example of higher-layer signaling configures the UE 1220 to switch its beam if the RSRP is below −110 dBm for a duration of 10 ms, subject to the hysteresis parameter of 3 dB. Other examples using SINR and angular direction may be defined in a similar manner.

Another example of the higher-layer signaling (e.g. RRC) corresponding to beam switching based on SINR is provided below:

```
BeamSwitchTriggerConfig = {
  beamSwitchSINR = {
    beamSwitchThreshold = {−6dB},
    hysteresis = {3dB},
    timeToTrigger = {10ms}
  }
}
```

The above example of higher-layer signaling configures the UE 1220 to switch its beam if the SINR is below −6 dB for a duration of 10 ms, subject to the hysteresis parameter of 3 dB.

Another example of higher-layer signaling (e.g. RRC) corresponding to beam switching based on Zenith angle is provided below:

```
BeamSwitchTriggerConfig = {
  beamSwitchZenithAngle = {
    beamSwitchThreshold = {10deg},
    hysteresis = {2deg},
    timeToTrigger = {50ms}
  }
}
```

The above example of higher-layer signaling configures the UE 1220 to switch its beam if the Zenith Angle is above 10 degrees for a duration of 50 ms, subject to the hysteresis parameter of 2 degrees. The UE 1220 may switch to using another beam, e.g. the beam 1230 corresponding to 0 degrees (i.e. Zenith BAI=011).

In another example, the UE 1220 may use the degradation in the reference signal received quality (RSRQ) as a trigger for beam switching. An example of the higher-layer signaling (e.g. RRC) corresponding to beam switching based on RSRQ is provided below:

```
BeamSwitchTriggerConfig = {
  beamSwitchRSRQ = {
    beamSwitchThreshold = {−6dB},
    hysteresis = {3dB},
    timeToTrigger = {10ms}
  }
}
```

The above example of higher-layer signaling configures the UE 1220 to switch its beam if the RSRQ is below −6 dB for a duration of 10 ms, subject to the hysteresis parameter of 3 dB.

FIG. 12C illustrates an example 1200C of a BAI switching based on a visibility cone in which some example embodiments of the present disclosure may be implemented. The example 1200 C may be a scenario after the triggering of the BAI switching in the example 1200B in FIG. 12B. The same number reference in FIGS. 12B and 12C refer to the same element, and detail description of the element in FIG. 12C is thus omitted. As shown in the FIG. 12C, when the NT-TRP 1215 exits the visibility cone of the UE 1220, a beam switching for the UE 1220 is triggered. The UE 1220 switches to another beam (e.g., the beam 1230) among the activated beams and may communicate with the NT-TRP 1210 located in the cone region 1205 of the UE 1220. The NT-TRP 1210 can be an implementation of the NT-TRP 172 in FIGS. 1, 2, and 3.

By triggering a beam switching (or a BAI switching) based on a cone region of the UE, such a transition may be seamless as far as the UE is concerned because the UE didn't leave its coverage area and therefore its physical layer parameters and other higher-layer parameters haven't changed. The change was limited to the beam that the UE may be using to communicate with the NT-TRP. In addition, the cone region constraining how far the Zenith BAIs go may also act as a constraint on physical parameters such as the propagation delay and therefore the Timing Advance to maintain UL synchronization.

In a fourth example implementation, the feature of a default Zenith BAI may be introduced. In one scenario, when a NT-TRP moves away from the UE's visibility cone, the UE may switch its beam towards another NT-TRP that is located within the UE's visibility cone. In another scenario, when a UE is in an idle mode, then the UE may use a Zenith BAI by default and may wait until the UE detects a beam from a NT-TRP using that default Zenith BAI in order to initiate procedures, e.g., an initial access procedure.

When a UE is in an idle mode, the UE may not retain any of the previously provided higher-layer signaling (e.g. RRC) and it may rely on one or more “default” Zenith beams in order to receive, detect and measure reference signals transmitted in NT-TRP beams. Additionally or alternatively, the UE may rely on one or more “default” Zenith beams in order to receive, detect and decode physical layer transmissions (for example, PDCCH/PDSCH) for e.g. system information and/or paging transmitted in NT-TRP beams. As an example, the default Zenith BAI may be the beam whose angular direction is pointing at 0 degrees (i.e. pointing vertically towards the sky).

FIG. 13 illustrates an example 1300 of a default BAI in which some example embodiments of the present disclosure may be implemented. For example, the UE 1320 may be in an idle mode or a power sleep mode. The UE 1320 may use the beam 1330 associated with a default BAI to perform an initial access, or to monitor reference signals from the NT-TRP 1310 before waking up from the power sleep mode. The NT-TRP 1310 can be an implementation of the NT-TRP 172 in FIGS. 1, 2, and 3.

The UE 1320 may use the default Zenith BAI for the whole duration while the UE is in idle mode (or while the UE is in a power sleep mode associated with sleep or deep sleep). This effectively results in the UE performing detection and measurements on reference signals transmitted by NT-TRPs using the default Zenith BAI until the UE 1320 wakes up and/or performs an initial access to establish an RRC connection.

In some embodiments, there may be one or more default Zenith BAIs, then the UE would perform detection and measurements on reference signals using the one or more default Zenith BAIs.

The information of the Zenith BAI may be provided to devices, e.g., UEs, from higher-layers e.g. non-access stratum (NAS) layers. As an example, the UE's universal subscriber identity module (USIM) may contain Elementary Files associated with a non-terrestrial access type of service, and the Elementary File may include e.g. a Zenith BAI table (e.g., Table 4) and a default Zenith BAI (e.g., as shown in Table 5) to use from within that table.

TABLE 4
Zenith BAI table

| Zenith Angle [degrees] | 0 | −10 | 10 |
|---|---|---|---|
| BAI | 00 | 01 | 10 |

TABLE 5
Default Zenith BAI

| | |
|---|---|
| Default Zenith BAI | 00 |

The Zenith BAI table in Table 4 includes 3 entries corresponding to 3 Zenit angles: {0 degrees, −10 degrees and 10 degrees}. The default Zenith BAI in Table 5 is set to 00, which corresponds to the Zenith angle of 0 degrees, i.e. pointing vertically towards the sky. The values from these Elementary Files stored in the USIM may be passed down to the UE's physical layer using internal operating system implementation, protocol stack implementation or transfer from the UE's memory.

In some implementations, as a UE transitions from e.g., a connected mode to e.g. an idle mode, the UE may switch from an activated Zenith BAI (where the activation command was e.g. a MAC-CE activation command or a DCI-based activation command) to a default Zenith BAI. Additionally or alternatively, as a UE transitions from a power mode associated with e.g. connected mode to a power mode associated with e.g. deep sleep, the UE may switch from an activated Zenith BAI (where the activation command was e.g. a MAC-CE activation command or a DCI-based activation command) to a default Zenith BAI.

By performing beam switching to a beam associated with a default BAI, power consumption may be reduced as UEs don't have to spend a lot of processing power searching and scanning for beams from NT-TRPs because the UE uses its default Zenith BAI (e.g. a beam pointing towards the sky) as the default beam. By performing beam switching to a beam associated with a default BAI, a seamless transition may be enabled as far as the UE is concerned because the UE didn't leave its coverage area and therefore its physical layer parameters haven't changed. The change was limited to the beam that the UE may be using to communicate with the NT-TRP. Another benefit for UEs in idle mode may be that it may lower the complexity in terms of performing measurements on different beams transmitted from NT-TRPs, because the UE would use the default Zenith BAIs while performing measurements on reference signals rather than try all of the Zenith BAIs. In addition, constraining how far the Zenith BAIs go may also act as a constraint on physical parameters such as the propagation delay and therefore the Timing Advance to maintain UL synchronization.

In some embodiments, the reference signals transmitted on different beams by a given NT-TRP may be generated using different “physical beam identities”, in which case the operation of beam switching may require the UE to search for new reference signals. If the UE has multiple active Zenith BAIs, the UE may detect those new reference signals using one of the other activated Zenith beams and select the Zenith BAI where the UE was able to detect the strongest reference signals in terms of e.g. RSRP. If the UE only has active Zenith BAIs, the UE may select a default Zenith BAI, e.g., the Zenith BAI corresponding to an angular direction of 0 degrees.

In some implementations, the BAI may be a BAI in the Azimuth domain, i.e. a beam pointing in a given direction in the horizontal domain. In some embodiments, the UE may be configured with a Zenith BAI table and an Azimuth BAI table. In some embodiments, the default Zenith BAI may be associated with a “Beam Hopping” pattern, where the beam hopping pattern may be configured as a time and/or frequency domain pattern indicating in which resources beams may be transmitted on.

In some implementations, the UE may have some capability in terms of the angular range it supports in e.g. the Zenith domain. In one example, the UE may communicate this capability in its UE Capability Report to the network, the UE may communicate this capability using a higher-layer parameter which may indicate the maximum angle of the so-called “visibility cone” in e.g. degrees. In a second example, the UE may not communicate this Capability parameter to the network and this Capability parameter may be embedded within the UE's internal hardware and may apply any higher-layer signaling related to Zenith BAIs based on its internal hardware, the UE may then report to the network which Zenith BAIs have been applied by the UE.

In some implementations, the UE may have some capability in terms of the number of Tx/Rx beams it supports in e.g. the Zenith domain. In one example, the UE may communicate this capability in its UE Capability Report to the network, the UE may communicate this capability using a higher-layer parameter which may indicate the maximum number of Zenith BAIs the UE may supports within the so-called “visibility cone”. In a second example, the UE may not communicate this Capability parameter to the network and this Capability parameter may be embedded within the UE's internal hardware and may apply any higher-layer signaling related to Zenith BAIs based on its internal hardware, the UE may then report to the network which Zenith BAIs have been applied by the UE.

In some implementations, the UE may have some capability in terms of the angular range it supports in e.g. the Azimuth domain. In one example, the UE may communicate this capability in its UE Capability Report to the network, the UE may communicate this capability using a higher-layer parameter which may indicate the maximum angle of the so-called “visibility cone” in e.g. degrees. In a second example, the UE may not communicate this Capability parameter to the network and this Capability parameter may be embedded within the UE's internal hardware and may apply any higher-layer signaling related to Azimuth BAIs based on its internal hardware, the UE may then report to the network which Azimuth BAIs have been applied by the UE.

In some implementations, the UE may have some capability in terms of the number of Tx/Rx beams it supports in e.g. the Azimuth domain. In one example, the UE may communicate this capability in its UE Capability Report to the network, the UE may communicate this capability using a higher-layer parameter which may indicate the maximum number of Azimuth BAIs the UE may supports within the so-called “visibility cone”. In a second example, the UE may not communicate this Capability parameter to the network and this Capability parameter may be embedded within the UE's internal hardware and may apply any higher-layer signaling related to Azimuth BAIs based on its internal hardware, the UE may then report to the network which Azimuth BAIs have been applied by the UE.

In some implementations, the network may transmit a DCI format to the UE, where the DCI format may carry a ‘defaultZenithBAI’ field, which may have a bitwidth of e.g. 4 bits and may carry a quantized value of a BAI. Such a table of quantized values of BAI may have been provided to the UE by the network using e.g. higher-layer signaling. If the DCI format includes a ‘defaultZenithBAI’ field, then the UE may switch its Tx/Rx beam from the current beam to the Tx/Rx beam whose boresight points in the direction corresponding to the value provided in the ‘defaultZenithBAI’ field. If the DCI format doesn't include a ‘defaultZenithBAI’ field, then the UE may continue using its current Tx/Rx beam for receiving e.g. PDCCH/PDSCH and/or transmitting e.g. PUCCH/PUSCH. It should be noted that the UE may need a certain time interval, which may be called e.g. beam application time, in order to switch its Tx/Rx beam from the current beam to the Tx/Rx beam whose boresight points in the direction indicated by the value corresponding to the value provided in the ‘defaultZenithBAI’ field.

In some implementations, the network may transmit a DCI format to the UE, where the DCI format may carry a ‘zenithBAI’ field, which may have a bitwidth of e.g. 4 bits and may carry a quantized value of a BAI. Such a table of quantized values of BAI may have been provided to the UE by the network using e.g. higher-layer signaling. If the DCI format includes a ‘zenithBAI’ field, then the UE may switch its Tx/Rx beam from the current beam to the Tx/Rx beam whose boresight points in the direction corresponding to the value provided in the ‘zenithBAI’ field. If the DCI format doesn't include a ‘zenithBAI’ field, then the UE may continue using its current Tx/Rx beam for receiving e.g. PDCCH/PDSCH and/or transmitting e.g. PUCCH/PUSCH. It should be noted that the UE may need a certain time interval, which may be called e.g. beam application time, in order to switch its Tx/Rx beam from the current beam to the Tx/Rx beam whose boresight points in the direction indicated by the value corresponding to the value provided in the ‘zenithBAI’ field.

In some implementations, if the UE receives/detects/decodes a DCI format which may carry a ‘zenithBAI’ field and a ‘defaultZenithBAI’ field, then the UE may treat the DCI format as invalid as a UE may expect a DCI format to carry one but not both of ‘zenithBAI’ and ‘defaultZenithBAI’ fields.

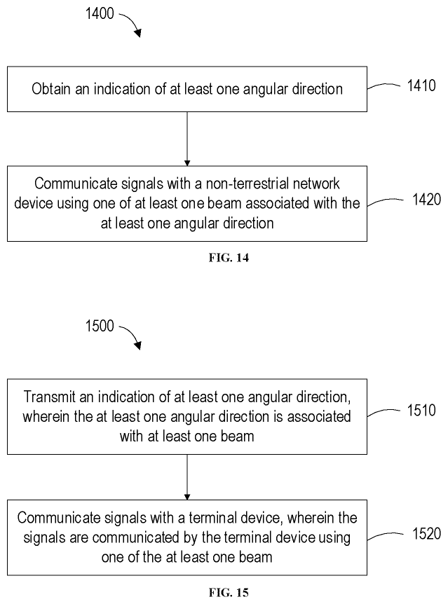

FIG. 14 illustrates an example of a method implemented at a terminal device 910 in which some example embodiments of the present disclosure may be implemented. The terminal device 910 in FIG. 9 can be implemented as the UEs in FIGS. 10-13.

In the method 1400, at 1410, the terminal device 910 obtains an indication of at least one angular direction. At 1420, the terminal device 910 communicates signals with a non-terrestrial network device using one of at least one beam associated with the at least one angular direction.

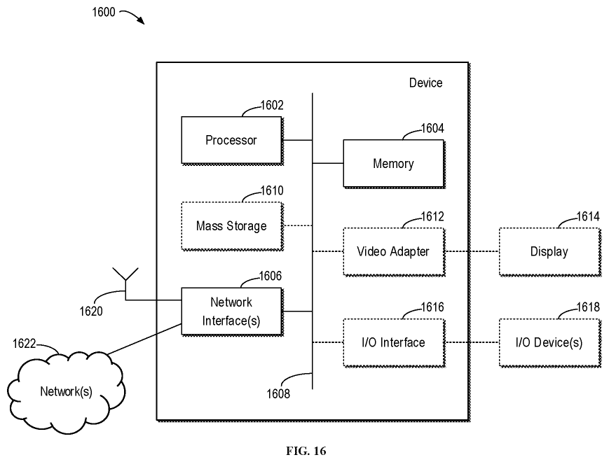

FIG. 15 illustrates an example of a method implemented at a NTN device 972 in which some example embodiments of the present disclosure may be implemented. The NTN device 972 can be implemented as the NT-TRPs in FIGS. 10-13.

In the method 1500, at 1510, the NTN device 972 transmits an indication of at least one angular direction, wherein the at least one angular direction is associated with at least one beam. At 1520, the NTN device 972 communicates signals with a terminal device, wherein the signals are communicated by the terminal device using one of the at least one beam.

FIG. 16 is a block diagram of an electronic device (ED) 1600 that may be used for implementing the devices, such as the terminal device 910, the first network device 905, or the NTN device 972 and methods such as 1400, or 1500 disclosed herein. In some embodiments, the device 1600 may be an element of communications network infrastructure, such as a base station (for example, a NodeB, an evolved Node B (eNodeB, or eNB), a next generation NodeB (sometimes referred to as a gNodeB or gNB), a home subscriber server (HSS), a gateway (GW) such as a packet gateway (PGW) or a serving gateway (SGW) or various other nodes or functions within a core network (CN) or a Public Land Mobility Network (PLMN). In other embodiments, the device 1600 may be a device that connects to the network infrastructure over a radio interface, such as a mobile phone, smart phone or other such device that may be classified as a User Equipment (UE). In some embodiments, the device 1600 may be a Machine Type Communications (MTC) device (also referred to as a machine-to-machine (M2M) device), or another such device that may be categorized as a UE despite not providing a direct service to a user. In some embodiments, the device 1600 may be a road side unit (RSU), a vehicle UE (V-UE), pedestrian UE (P-UE) or an infrastructure UE (I-UE). In some scenarios, the device 1600 may also be referred to as a mobile device, a term intended to reflect devices that connect to mobile network, regardless of whether the device itself is designed for, or capable of, mobility. Specific devices may utilize all of the components shown or only a subset of the components, and levels of integration may vary from device to device. Furthermore, the device 1600 may contain multiple instances of a component, such as multiple processors, memories, transmitters, receivers, etc.

The device 1600 typically includes a processor 1602, such as a Central Processing Unit (CPU), and may further include specialized processors such as a Graphics Processing Unit (GPU) or other such processor, a memory 1604, a network interface 1606 and a bus 1608 to connect the components of the device 1600. The device 1600 may optionally also include components such as a mass storage device 1610, a video adapter 1612, and an I/O interface 1616 (shown in dashed lines).

The memory 1604 may comprise any type of non-transitory system memory, readable by the processor 1602, such as static random access memory (SRAM), dynamic random access memory (DRAM), synchronous DRAM (SDRAM), read-only memory (ROM), or a combination thereof. In an embodiment, the memory 1604 may include more than one type of memory, such as ROM for use at boot-up, and DRAM for program and data storage for use while executing programs. The bus 1608 may be one or more of any type of several bus architectures including a memory bus or memory controller, a peripheral bus, or a video bus.

The device 1600 may also include one or more network interfaces 1606, which may include at least one of a wired network interface and a wireless network interface. As illustrated in FIG. 16, network interface 1606 may include a wired network interface to connect to a network 1622, and also may include a radio access network interface 1620 for connecting to other devices over a radio link. When the device 1600 is a network infrastructure element, the radio access network interface 1620 may be omitted for nodes or functions acting as elements of the PLMN other than those at the radio edge (e.g., an eNB). When the device 1600 is infrastructure at the radio edge of a network, both wired and wireless network interfaces may be included. When the device 1600 is a wirelessly connected device, such as a User Equipment, radio access network interface 1620 may be present and it may be supplemented by other wireless interfaces such as WiFi network interfaces. The network interfaces 1606 allow the device 1600 to communicate with remote entities such as those connected to network 1622.

The mass storage 1610 may comprise any type of non-transitory storage device configured to store data, programs, and other information and to make the data, programs, and other information accessible via the bus 1608. The mass storage 1610 may comprise, for example, one or more of a solid state drive, hard disk drive, a magnetic disk drive, or an optical disk drive. In some embodiments, the mass storage 1610 may be remote to the device 1600 and accessible through use of a network interface such as interface 1606. In the illustrated embodiment, the mass storage 1610 is distinct from memory 1604 where it is included, and may generally perform storage tasks compatible with higher latency, but may generally provide lesser or no volatility. In some embodiments, the mass storage 1610 may be integrated with a heterogeneous memory 1604.

The optional video adapter 1612 and the I/O interface 1616 (shown in dashed lines) provide interfaces to couple the device 1600 to external input and output devices. Examples of input and output devices include a display 1614 coupled to the video adapter 1612 and an I/O device 1618 such as a touch-screen coupled to the I/O interface 1616. Other devices may be coupled to the device 1600, and additional or fewer interfaces may be utilized. For example, a serial interface such as Universal Serial Bus (USB) (not shown) may be used to provide an interface for an external device. Those skilled in the art will appreciate that in embodiments in which the device 1600 is part of a data center, I/O interface 1616 and Video Adapter 1612 may be virtualized and provided through network interface 1606.

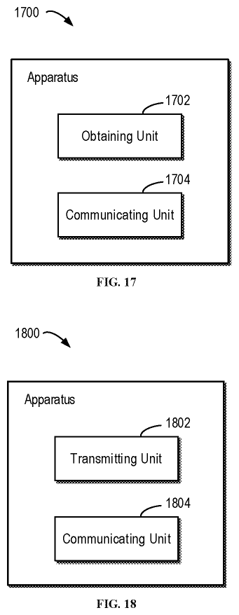

FIG. 17 is a schematic diagram of a structure of an apparatus 1700 in accordance with some embodiments of the present disclosure. As shown in FIG. 17, the apparatus 1700 includes an obtaining unit 1702 and a communicating unit 1704. The apparatus 1700 may be applied to the communication system as shown in FIG. 1, and may implement any of the methods provided in the foregoing embodiments. Optionally, a physical representation form of the apparatus 1700 may be a communication device, for example, a terminal device 910. Alternatively, the apparatus 1700 may be another apparatus that can implement a function of a communication device, for example, a processor or a chip inside the communication device. Specifically, the apparatus 1700 may be some programmable chips such as a field-programmable gate array (field-programmable gate array, FPGA), a complex programmable logic device (complex programmable logic device, CPLD), an application-specific integrated circuit (application-specific integrated circuits, ASIC), or a system on a chip (System on a chip, SOC).

In some embodiments, the obtaining unit 1702 may be configured to obtain an indication of at least one angular direction. The communicating unit 1704 may be configured to communicate signals with a non-terrestrial network device using one of at least one beam associated with the at least one angular direction.

In some other embodiments, the apparatus 1700 can include various other units or modules which may be configured to perform various operations or functions as described in connection with the foregoing method embodiments. The details can be obtained referring to the detailed description of the foregoing method embodiments and are not described herein again.

FIG. 18 is a schematic diagram of a structure of an apparatus 1800 in accordance with some embodiments of the present disclosure. As shown in FIG. 18, the apparatus 1800 includes a transmitting unit 1802 and a communicating unit 1804. The apparatus 1800 may be applied to the communication system as shown in FIG. 1, and may implement any of the methods provided in the foregoing embodiments. Optionally, a physical representation form of the apparatus 1800 may be a communication device, for example, a NTN device 972. Alternatively, the apparatus 1800 may be another apparatus that can implement a function of a communication device, for example, a processor or a chip inside the communication device. Specifically, the apparatus 1800 may be some programmable chips such as a field-programmable gate array (field-programmable gate array, FPGA), a complex programmable logic device (complex programmable logic device, CPLD), an application-specific integrated circuit (application-specific integrated circuits, ASIC), or a system on a chip (System on a chip, SOC).

In some embodiments, the transmitting unit 1802 may be configured to transmit an indication of at least one angular direction, wherein the at least one angular direction is associated with at least one beam. The communicating unit 1804 may be configured to communicate signals with a terminal device, wherein the signals are communicated by the terminal device using one of the at least one beam.

In some other embodiments, the apparatus 1800 can include various other units or modules which may be configured to perform various operations or functions as described in connection with the foregoing method embodiments. The details can be obtained referring to the detailed description of the foregoing method embodiments and are not described herein again.

It should be noted that division into the units or modules in the foregoing embodiments of the present disclosure is an example, and is merely logical function division. In actual implementation, there may be another division manner. In addition, function units in embodiments of the present disclosure may be integrated into one processing unit, or may exist alone physically, or two or more units may be integrated into one unit. The integrated unit may be implemented in a form of hardware, or may be implemented in a form of a software function unit.

When the integrated unit is implemented in a form of a software function unit and sold or used as an independent product, the integrated unit may be stored in a computer-readable storage medium. Based on such an understanding, the technical solutions of the present disclosure essentially, or all or some of the technical solutions may be implemented in a form of a software product. The computer software product is stored in a storage medium and includes several instructions for instructing a computer device (which may be a personal computer, a server, or a network device) or a processor (processor) to perform all or some of the steps of the methods described in embodiments of the present disclosure. The foregoing storage medium includes any medium that can store program code, such as a USB flash drive, a removable hard disk, a read-only memory (Read-Only Memory, ROM), a random access memory (Random Access Memory, RAM), a magnetic disk, or an optical disc.

Based on the foregoing embodiments, an embodiment of this application further provides a computer program. When the computer program is run on a computer, the computer is enabled to perform any of the methods provided in the foregoing embodiments.

Based on the foregoing embodiments, an embodiment of this application further provides a computer-readable storage medium. The computer-readable storage medium stores a computer program. When the computer program is executed by a computer, the computer is enabled to perform the any of the methods provided in the foregoing embodiments. The storage medium may be any usable medium that can be accessed by a computer. By way of example and not limitation, the computer-readable medium may include a RAM, a ROM, an EEPROM, a CD-ROM or another optical disk storage, a magnetic disk storage medium or another magnetic storage device, or any other medium that can be used to carry or store expected program code in a form of an instruction or a data structure and that can be accessed by a computer.

Based on the foregoing embodiments, an embodiment of the present disclosure further provides a chip. The chip is configured to read a computer program stored in a memory, to implement any of the methods provided in the foregoing embodiments.

Based on the foregoing embodiments, an embodiment of the present disclosure provides a chip system. The chip system includes a processor, configured to support a computer apparatus in implementing functions related to communication devices in the foregoing embodiments. In a possible design, the chip system further includes a memory, and the memory is configured to store a program and data that are necessary for the computer apparatus. The chip system may include a chip, or may include a chip and another discrete component.

Based on the foregoing embodiments, an embodiment of the present disclosure provides an apparatus/chipset system comprising means (e.g., at least one processor) to implement a method implemented by (or at) a UE of the present disclosure. The apparatus/chipset system may be the UE (that is, a terminal device) or a module/component in the UE. In details, the at least one processor may execute instructions stored in a computer-readable medium to implement the method.

Based on the foregoing embodiments, an embodiment of the present disclosure provides an apparatus/chipset system comprising means (e.g., at least one processor) to implement the method implemented by (or at) a network device (e.g., base station) of the present disclosure. The apparatus/chipset system may be the network device or a module/component in the network device. In details, the at least one processor may execute instructions stored in a computer-readable medium to implement the method. In some aspects of the present disclosure, there is provided a system comprising at least one of an apparatus in (or at) a UE of the present disclosure, or an apparatus in (or at) a network device of the present disclosure.

It will be appreciated that any module, component, or device disclosed herein that executes instructions may include, or otherwise have access to, a non-transitory computer/processor readable storage medium or media for storage of information, such as computer/processor readable instructions, data structures, program modules and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e., DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device/apparatus or accessible or connectable thereto. Computer/processor readable/executable instructions to implement a method, an application or a module described herein may be stored or otherwise held by such non-transitory computer/processor readable storage media.

A person skilled in the art should understand that embodiments of the present disclosure may be provided as a method, a system, or a computer program product. Therefore, the present disclosure may be in a form of a hardware-only embodiment, a software-only embodiment, or an embodiment combining software and hardware aspects. In addition, the present disclosure may be in a form of a computer program product implemented on one or more computer-usable storage media (including but not limited to a magnetic disk memory, a CD-ROM, an optical memory, and the like) including computer-usable program code.

The present disclosure is described with reference to the flowcharts and/or block diagrams of the method, the device (system), and the computer program product according to the present disclosure. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of another programmable data processing device to generate a machine, so that the instructions executed by a computer or a processor of another programmable data processing device generate an apparatus for implementing a specific function in one or more processes in the flowcharts and/or in one or more blocks in the block diagrams.

These computer program instructions may alternatively be stored in a computer-readable memory that can indicate a computer or another programmable data processing device to work in a specific manner, so that the instructions stored in the computer-readable memory generate an artifact that includes an instruction apparatus. The instruction apparatus implements a specific function in one or more processes in the flowcharts and/or in one or more blocks in the block diagrams.

These computer program instructions may alternatively be loaded onto a computer or another programmable data processing device, so that a series of operations and steps are performed on the computer or the another programmable device, to generate computer-implemented processing. Therefore, the instructions executed on the computer or the another programmable device provide steps for implementing a specific function in one or more processes in the flowcharts and/or in one or more blocks in the block diagrams.

The solutions described in the disclosure is applicable to a next generation (e.g. sixth generation (6G) or later) network, or a legacy (e.g. 5G, 4G, 3G or 2G) network.

It is clear that a person skilled in the art may make various modifications and variations to the present disclosure without departing from the protection scope of the present disclosure. Thus, the present disclosure is intended to cover these modifications and variations, provided that they fall within the scope of the claims of the present disclosure and their equivalent technologies. Although this disclosure refers to illustrative embodiments, this is not intended to be construed in a limiting sense. Various modifications and combinations of the illustrative embodiments, as well as other embodiments of the disclosure, will be apparent to persons skilled in the art upon reference to the description. When combining two or more embodiments, not all the features in the embodiments to be combined are necessary for the combination.

Features disclosed herein in the context of any particular embodiments may also or instead be implemented in other embodiments. Method embodiments, for example, may also or instead be implemented in apparatus, system, and/or computer program product embodiments. In addition, although embodiments are described primarily in the context of methods and apparatus, other implementations are also contemplated, as instructions stored on one or more non-transitory computer-readable media, for example. Such media could store programming or instructions to perform any of various methods consistent with the present disclosure.

What is claimed is:

1. A method comprising:
obtaining, by a terminal device, an indication of at least one angular direction; and
communicating, by the terminal device, signals with a non-terrestrial network device using one beam of at least one beam associated with the at least one angular direction.

2. The method of claim 1, further comprising:
receiving an indication of an association between one or more indications of one or more angular directions and one or more beams,
wherein the one or more angular directions comprise the at least one angular direction, and the one or more beams comprise the at least one beam.

3. The method of claim 2, further comprising:
activating the at least one beam associated with the at least one angular direction; and
deactivating remaining beams associated with remaining angular directions different from the at least one angular direction,
wherein the one or more angular directions comprise the remaining angular directions, and the one or more beams comprise the remaining beams.

4. The method of claim 3, wherein the indication of the at least one angular direction is carried in one of: media access control (MAC) control element (CE) signaling, radio resource control (RRC) signaling, or downlink control information (DCI), and
wherein the indication of the association is carried in the RRC signaling.

5. The method of claim 1, wherein the indication of the at least one angular direction indicates a plurality of angular directions in an order, and wherein the order indicates a priority of using the plurality of angular directions.

6. The method of claim 1, wherein one angular direction of the at least one angular direction is indicative of a direction applied in at least one of:
an Azimuth domain;
a Zenith domain; or
an Elevation domain.

7. The method of claim 1, wherein the at least one angular direction comprises a plurality of angular directions including a first angular direction and a second angular direction, wherein the at least one beam comprises a first beam associated with the first angular direction and a second beam associated with the second angular direction, and the communicating the signals using the one beam of the at least one beam comprises:
receiving the signals using the first beam;
determining a quality degradation associated with the signals received using the first beam, wherein the first beam is associated with an outermost angular direction in a cone region constrained by the plurality of angular directions; and
performing a beam switching from the first beam to the second beam.

8. The method of claim 7, wherein the determining the quality degradation associated with the signals comprises at least one of:
determining that a reference signal received power (RSRP) of the signals is below a first threshold for a first duration;
determining that a reference signal received quality (RSRQ) of the signals is below a second threshold for a second duration;
determining that a signal to interference and noise ratio (SINR) of the signals is below a third threshold for a third duration; or
determining that the signals are received using the first beam for a fourth duration.

9. The method of claim 1, wherein the communicating the signals using the one beam of the at least one beam comprises:
detecting reference signals using the at least one beam;
determining a beam with a strongest reference signal strength based on the reference signals, wherein the beam belongs to the at least one beam; and
communicating the signals using the beam with the strongest reference signal strength.

10. The method of claim 1, wherein the at least one angular direction comprises a plurality of angular directions, and the method further comprises:
receiving an indication of a default angular direction, wherein the default angular direction belongs to the plurality of angular directions; and
performing a beam switching to a beam associated with the default angular direction upon determining one of:
a quality degradation associated with the signals received using a first beam among the plurality of angular directions, wherein the first beam is associated with an outermost angular direction in a cone region constrained by the plurality of angular directions;
a state transition of the terminal device from an RRC connected state to a power sleep mode; or
a state transition of the terminal device from the RRC connected state to an idle mode.

11. A method comprising:
transmitting, by a non-terrestrial network device, an indication of at least one angular direction, wherein the at least one angular direction is associated with at least one beam; and
communicating, by the non-terrestrial network device, signals with a terminal device, wherein the signals are communicated using one beam of the at least one beam.

12. The method of claim 11, further comprising:
transmitting an indication of an association between one or more indications of one or more angular directions and one or more beams,
wherein the one or more angular directions comprise the at least one angular direction and the one or more beams comprise the at least one beam.

13. The method of claim 12, wherein the indication of the at least one angular direction is carried in one of: media access control (MAC) control element (CE) signaling, radio resource control (RRC) signaling, or downlink control information (DCI), and
wherein the indication of the association is carried in the RRC signaling.

14. The method of claim 11, wherein the indication of the at least one angular direction indicates a plurality of angular directions in an order, and wherein the order indicates a priority of using the plurality of angular directions.

15. The method of claim 11, wherein one angular direction of the at least one angular direction is indicative of a direction applied in at least one of:
an Azimuth domain;
a Zenith domain; or
an Elevation domain.

16. The method of claim 11, wherein the at least one angular direction comprises a plurality of angular directions, and the method further comprises:
transmitting a configuration triggering a beam switching, wherein the configuration indicates at least one of:
a first threshold and a first duration for a reference signal received power (RSRP);
a second threshold and a second duration for a reference signal received quality (RSRQ);
a third threshold and a third duration for a signal to interference and noise ratio (SINR); or
a fourth duration for an outermost angular direction in a cone region constrained by the plurality of angular directions.

17. The method of claim 1, further comprising:
transmitting a second indication indicating one angular direction of the at least one angular direction,
wherein the signals are communicated using the one beam associated with the one angular direction of the at least one angular direction, and wherein the one beam belongs to the at least one beam.

18. The method of claim 11, further comprising:
transmitting an indication of one angular direction of the at least one angular direction and an indication of a correction on the one angular direction of the at least one angular direction,
wherein the signals are communicated by the terminal device using the one beam associated with the one angular direction of the at least one angular direction applied with the correction, and wherein the one beam belongs to the at least one beam.

19. The method of claim 11, further comprising:
transmitting an indication of a default angular direction, wherein the default angular direction belongs to the at least one angular direction.

20. The method of claim 19, wherein the default angular direction is associated with a time domain pattern, a frequency domain pattern, or a time-frequency domain pattern indicative of resources for communicating the signals.
